(19) United States
(12) Patent Application Publication
(10) Pub. No.: US 2024/0378191 A1
(43) Pub. Date: Nov. 14, 2024

(54) SYSTEMS AND METHODS FOR TRANSACTION COMMIT AND LOCK RELEASE ATOP PARTITIONED CONSENSUS

(71) Applicant: Cockroach Labs, Inc., New York, NY (US)

(72) Inventors: Sumeer Kumar Bhola, Brooklyn, NY (US); Nathan J. VanBenschoten, Brooklyn, NY (US); Tobias Grieger, Bonn (DE); Andrew E. Kimball, Moraga, CA (US)

(21) Appl. No.: 18/316,851

(22) Filed: May 12, 2023

(51) Int. Cl. G06F 16/23

(52) U.S. Cl. CPC G06F 16/2379; G06F 16/2343

(57) ABSTRACT

Systems and methods for executing conflicting read and write transactions based on a lock release protocol are provided. An intent present at a version of a key can be identified by a first transaction. The first transaction can verify whether the intent corresponds to a second transaction having a simple-committed type to observe the intent as a committed value and proceed with execution or to wait on the second transaction to complete execution. Based on the second transaction being a simple-committed type, the first transaction can determine a provisional value included in the intent as a read value or write a new intent to a new version of the key without waiting for the second transaction to explicitly commit.

### FIELD OF TECHNOLOGY

The present disclosure relates generally to methods and systems for managing transactions within a distributed database and more particularly, to execution of conflicting transactions in the distributed database.

### BACKGROUND

The foregoing examples of the related art and limitations therewith are intended to be illustrative and not exclusive, and are not admitted to be “prior art.” Other limitations of the related art will become apparent to those of skill in the art upon a reading of the specification and a study of the drawings. In some cases, relational databases can apply replication to ensure data survivability, where data is replicated among one or more computing devices (“nodes”) of a group of computing devices (“cluster”). A relational database may store data within one or more ranges, where a range includes one or more key-value (KV) pairs and can be replicated among one or more nodes of the cluster. A range may be a data partition of a data table (“table”), where a table may include one or more ranges. The database may receive requests (e.g., such as read or write operations originating from client devices) directed to KV data stored by the database.

In some cases, with respect to a distributed storage system for a database as described herein, individual nodes can store multiple copies (“replicas”) of the same data and can store different data partitions (“ranges”) of data, where (i) replication via a number of replicas provides fault tolerance, and (ii) partitioning data into ranges provides horizontal scalability. Modern distributed systems require both replication and partitioning.

Within this landscape, a distributed storage system can require algorithms to efficiently manipulate stored data. Distributed online transaction processing (OLTP) systems like the systems described herein adhere to strong transactional semantics using a pair of capabilities. First, the system provides transactions with strong (e.g., linearizable) consistency within a single replication group (e.g., replicas of a particular range) using distributed consensus, such that a change made to a single datum (e.g., range) in the replication group is instantaneously observable from all replicas in that replication group (e.g., without risk of staleness). A distributed consensus protocol (e.g., Raft protocol) as described herein may include voting between a leader replica and follower replicas. Second, the system provides transactions with atomic commitment to multiple datums (e.g., ranges) spread across different replication groups, such that the changes made in tandem to multiple pieces of data have “all or nothing” behavior and are instantaneously observable.

Conventionally, the problems associated with distributed consensus and atomic commitment are treated separately in systems having such architecture. Atomic commitment algorithms traditionally persist a state on each of their “participant” ranges (e.g., ranges subject to the atomic commit protocol). These systems use distributed consensus within each range to provide highly available, fault-tolerant persistence to atomic commit. As a result, these systems are referred to as “layering” atomic commitment on top of distributed consensus. However, layering of atomic commitment on distributed consensus risks compromising performance. Specifically, distributed consensus and atomic commitment are both distributed algorithms that require synchronous cross-node communication and persistence. Using distributed consensus as the persistence for atomic commitment results in a latency multiplication effect, where each step in the atomic commitment protocol waits for a full round of execution of the distributed consensus protocol.

At a high level, a conventional atomic commit protocol (e.g., a two-phase commit (2PC) protocol) for committing write operations of a transaction includes a “prepare” phase, a “commit” phase, and a “release” phase. During the prepare phase of a transaction, replicas of range(s) subject to the transaction are consulted by a coordinator process (e.g., a transaction coordinator operating at a gateway node or another node) to determine whether the committing transaction is allowed to commit. When the committing transaction is allowed to commit, each replica acquires locks locally on behalf of the transaction. The prepare phase may last for a duration greater than or equal to one round of consensus among replicas of each range subject to the write transaction. During the commit phase, the coordinator process determines whether to commit or abort the transaction based on the votes of the replicas in the prepare phase and replicates the decision to commit or abort the transaction to the replicas. Such a commit phase avoids blocking or otherwise stalling a transaction by making the decision to commit or abort the transaction highly available among replicas of participating ranges. The commit phase may last for a duration greater than or equal to one round of consensus among replicas of the range storing a transaction record for the transaction. To enable an atomic commit protocol, the votes to commit the transaction may be required to be unanimous among the participant ranges subject to the transaction for the transaction to commit, where a majority of replicas voting within each participating range may be required to agree to commit the transaction. After completion of the commit phase, the coordinator process may send an acknowledgement of the committed transaction to the client device from which the transaction was initiated. During the release phase, the coordinator process sends notifications to the replicas of the result of the transaction, thereby allowing the replicas to release locks.

Based on the conventional layering of the atomic commit over distributed consensus, each of the prepare, commit, and release phases must wait for a respective round of distributed consensus (e.g., voting among leader replica(s) and follower replicas) before completion. The client device initiating the commit request can receive an indication of the outcome of the transaction after the commit phase is completed, thereby requiring the client device to wait for a duration greater than or equal to two sequential rounds of distributed consensus to learn whether the transaction was committed or aborted. Further, subsequent transactions waiting to acquire conflicting locks (e.g., locks on the same KV data as the first transaction) must wait until after the release phase before acquiring locks, thereby requiring the subsequent transaction to wait for a duration of greater than or equal to three rounds of distributed consensus before the transaction can acquire their own respective locks. Accordingly, conventional implementations of atomic commit and distributed consensus protocols can result in reduced performance (e.g., reduced latency) for write operations included in an initial transaction and read and write operations included in subsequent transactions.

### SUMMARY

Methods and systems for improved execution of conflicting read and write transactions are disclosed. In one aspect, embodiments of the present disclosure feature a method for executing a conflicting read transaction. According to one embodiment, the method can include receiving, from a client device at a first computing node of a plurality of computing nodes, a first transaction directed to reading, at a first timestamp, a key included in a plurality of replicas of a partition stored by the plurality of computing nodes, where the key includes a plurality of versions each including a respective value and a respective timestamp for the value. The respective timestamp for each of the plurality of versions of the key may be at a timestamp at which a respective transaction that wrote the value for the version was committed. The method can include identifying, based on the first timestamp, the respective value of a corresponding version of the plurality of versions of the key, where the respective timestamp of the corresponding version of the key includes a second timestamp. The method can include determining the respective value of the corresponding version of the key includes an intent, where the intent was written by a second transaction at the second timestamp. The method can include determining, based on a type of the second transaction, a provisional value included in the intent as a read value for the first transaction.

Various embodiments of the method can include one or more of the following features. The intent can include the provisional value and a pointer to a transaction record corresponding to the second transaction, where the transaction record indicates a status of the second transaction. The identifying the respective value of the corresponding version of the plurality of versions of the key further can include identifying, based on the second timestamp being less than or equal to the first timestamp, the respective value of the corresponding version of the plurality of versions of the key. The method can further include determining the respective value of the corresponding version of the key includes a committed value, where the committed value was committed by the second transaction at the second timestamp. The method can further include determining the committed value as the read value for the first transaction. The method can further include determining, based on the determination the respective value of the corresponding version of the key includes the intent, the corresponding version of the key is not a most recent version of the key. The determining the corresponding version of the key is not a most recent version of the key can include identifying a key history corresponding to the key, where the key history includes indications of the plurality of versions of the key; comparing the second timestamp to the respective timestamps of the plurality of versions of the key included in the key history; and determining, based on the comparison of the second timestamp to the respective timestamps of the plurality of versions of the key, at least one timestamp of the respective timestamps of the plurality of versions of the key is greater than the second timestamp. The determining the provisional value included in the intent as the read value for the first transaction further can further include determining, based on the determination the corresponding version of the key is not the most recent version of the key, the provisional value included in the intent as the read value for the first transaction.

In some embodiments, the method can further include determining, based on the determination the respective value of the corresponding version of the key includes the intent, the corresponding version of the key is a most recent version of the key. The determining the corresponding version of the key is a most recent version of the key can include identifying a key history corresponding to the key, where the key history includes indications of the plurality of versions of the key; comparing the second timestamp to the respective timestamps of the plurality of versions of the key included in the key history; and determining, based on the comparison of the second timestamp to the respective timestamps of the plurality of versions of the key, the second timestamp is greater than each of the respective timestamps of the plurality of versions of the key. The method can further include determining, based on the determination the corresponding version of the key is the most recent version of the key, the type of the second transaction. The type of the second transaction is or otherwise includes a simple-committed type when (i) each of one or more intents written by the second transaction were written at the second timestamp, where the one or more intents include the intent, (ii) the second timestamp is equivalent to a commit timestamp for the second transaction, and (iii) zero of the one or more intents were removed during execution of the second transaction. The determining the provisional value included in the intent as the read value for the first transaction can further include determining, based on the type of the second transaction being or otherwise including the simple-committed type, the provisional value included in the intent as the read value for the first transaction. The method can further include determining, by a transaction coordinator operating at the first computing node, the type of the second transaction includes the simple-committed type; sending an indication of the type of the second transaction including the simple-committed type to each of the plurality of replicas of the partition; and storing, by each of the plurality of replicas of the partition, the indication.

In some embodiments, the method can further include determining the type of the second transaction by identifying an indication of the second transaction included in at least one of the plurality of replicas of the partition. The method can further include resolving, based on the type of the second transaction, the intent, by identifying an update to a status of the second transaction. In some cases, the resolving the intent can further include determining, based on the update, the respective value of the corresponding version of the key includes a committed value, where the committed value was committed by the second transaction at the second timestamp; and determining the committed value as the read value for the first transaction. In some cases, the resolving the intent can further include identifying, based on the update, the respective value of one of the plurality of versions of the key, where the respective value was committed by a third transaction at a third timestamp; and determining the respective value committed by the third transaction as the read value for the first transaction. The method can further include sending, from the first computing node to the client device, the read value for the first transaction.

In another aspect, embodiments of the present disclosure feature a method for executing a conflicting write transaction. According to one embodiment, the method can include receiving, from a client device at a first computing node of a plurality of computing nodes, a first transaction directed to writing, at a first timestamp, to a key included in a plurality of replicas of a partition stored by the plurality of computing nodes, where the key includes a plurality of versions each including a respective value and a respective timestamp for the value. The respective timestamp for each of the plurality of versions of the key may be at a timestamp at which a respective transaction that wrote the value for the version was committed. The method can include identifying a second timestamp as the respective timestamp of a most recent version of the plurality of versions of the key, where the most recent version of the key includes the second timestamp. The method can include determining, based on a comparison of the first timestamp to the second timestamp, the respective value of the most recent version of the key includes a second intent, where the second intent was written by a second transaction at the second timestamp. The method can include writing, based on a type of the second transaction, a new version of the key to the plurality of versions of the key at the first timestamp, where in the new version includes a first intent including a first provisional value and a first pointer to a first transaction record corresponding to the first transaction.

Various embodiments of the method can include one or more of the following features. The second intent can include a second provisional value and a second pointer to a second transaction record corresponding to the second transaction, where the second transaction record indicates a status of the second transaction. The method can further include comparing the first timestamp to the second timestamp; and increasing, based on the second timestamp being greater than or equal to the first timestamp, the first timestamp to be greater than the second timestamp. The determining the respective value of the most recent version of the key includes the second intent can further include comparing the first timestamp to the second timestamp; and determining, based on the second timestamp being less than the first timestamp, the respective value of the most recent version of the key includes the second intent. The method can further include determining the respective value of the most recent version of the key includes a committed value, where the committed value was written by the second transaction at the second timestamp; and writing, based on the determination the respective value of the most recent version of the key includes the committed value, the new version to the plurality of versions of the key at the first timestamp. The method can further include determining, based on the determination the respective value of the most recent version of the key includes the second intent, the type of the second transaction. The type of the second transaction is or otherwise includes a simple-committed type when (i) each of one or more intents written by the second transaction were written at the second timestamp, where the one or more intents include the intent, (ii) the second timestamp is equivalent to a commit timestamp for the second transaction, and (iii) zero of the one or more intents were removed during execution of the second transaction. The writing the new version to the plurality of versions of the key can further include writing, based on the type of the second transaction being or otherwise including the simple-committed type, the new version to the plurality of versions of the key.

In some embodiments, the method can further include determining, by a transaction coordinator operating at the first computing node, the type of the second transaction is or otherwise includes the simple-committed type; sending an indication of the type of the second transaction being or otherwise including the simple-committed type to each of the plurality of replicas of the partition; and storing, by each of the plurality of replicas of the partition, the indication. The method can further include determining the type of the second transaction by identifying an indication of the second transaction included in at least one of the plurality of replicas of the partition. In some cases, the plurality of replicas of the partition include a leader replica and two or more follower replicas, where the leader replica is configured to coordinate execution of a consensus protocol for write operations directed to the partition among a group including the leader replica and the two or more follower replicas. The writing the new version of the key to the plurality of versions of the key at the first timestamp can further include sending, from the leader replica to the two or more follower replicas, an indication of the first intent; sending, from the two or more follower replicas to the leader replica, respective acknowledgements of the first intent; and committing, at the leader replica, the first intent based on a majority of the group acknowledging the first intent. The method can further include resolving, based on the type of the second transaction, the intent, where the resolving can include identifying an update to a status of the second transaction; and writing, based on the update, the new version of the key to the plurality of versions of the key at the first timestamp or at a third timestamp, where the third timestamp is greater than the first timestamp and the second timestamp. The method can further include sending, from the first computing node to the client device, an indication of success for the first transaction.

In other aspects, the present disclosure features systems for executing a conflicting read transaction and a conflicting write transaction. The system can include corresponding computer systems, apparatus, and computer programs recorded on one or more computer storage devices, each configured to perform the actions of the methods described herein. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The above and other preferred features, including various novel details of implementation and combination of events, will now be more particularly described with reference to the accompanying figures and pointed out in the claims. It will be understood that the particular methods and systems described herein are shown by way of illustration only and not as limitations. As will be understood by those skilled in the art, the principles and features described herein may be employed in various and numerous embodiments without departing from the scope of the present disclosure. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of the present disclosure.

The foregoing Summary, including the description of some embodiments, motivations therefore, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 (“FIG. 1”) shows an illustrative distributed computing system, according to some embodiments.

FIG. 2A shows an example of execution of a read transaction at the computing system, according to some embodiments.

FIG. 2B shows an example of execution of a write transaction at the computing system, according to some embodiments.

FIG. 3 shows an example flowchart for a method for executing a conflicting read transaction at the computing system, according to some embodiments.

FIG. 4 shows an example flowchart for a method of executing a conflicting write transaction at the computing system, according to some embodiments.

FIG. 5 is a block diagram of an example computer system, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Methods and systems for executing conflicting transactions using an improved lock release protocol are disclosed. It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details.

### Motivation for Some Embodiments

As described above, conventional implementations of atomic commit and distributed consensus protocols can result in reduced latency performance for write operations included in an initial transaction and subsequent transactions. Such reduced latency performance can result from waiting on multiple rounds of distributed consensus among replicas of ranges. Accordingly, improved atomic commit and distributed consensus protocols are required that can reduce latencies for committing transactions and releasing acquired locks on KV data.

Systems and related methods are described herein for an improved atomic commitment protocol that can interface with a distributed consensus protocol. In some cases, implementation of such an improved protocol can reduce a latency-to-commit for a transaction by avoiding multiple sequential rounds of distributed consensus. As an example, using the improved atomic commitment protocol described herein, the atomicity point of the commit protocol for a transaction can be reached after waiting for only the latency of one round of distributed consensus, rather than the latency of two rounds of distributed consensus as practiced by the conventional atomic commit protocol. Such an implementation can reduce the latency for which a client device waits when committing a transaction by 50% (e.g., one round of distributed consensus).

In some cases, implementation of the atomic commitment protocol can reduce a latency-to-release for a transaction by avoiding multiple sequential rounds of distributed consensus. As another example, using the improved atomic commitment protocol described herein, locks on KV data can be released after waiting for only the latency of one round of distributed consensus, rather than the latency of three rounds of distributed consensus as practiced by the conventional atomic commit protocol. Such an implementation can reduce the latency that a transaction delays other different, conflicting transactions which are waiting to acquire an overlapping set of locks by up to (e.g., two rounds of distributed consensus). Removing the locks on the KV data after the one round of distributed consensus may be optimal, since the locking that constitutes that distributed consensus round can be overlapped with the write operations made by the transaction, which require the distributed consensus round for providing the durability property.

### Terms

“Cluster” generally refers to a deployment of computing devices that comprise a database. A cluster may include computing devices (e.g., computing nodes) that are located in one or more geographic locations (e.g., data centers). The one or more geographic locations may be located within a single geographic region (e.g., eastern United States, central United States, etc.) or more than one geographic location. For example, a cluster may include computing devices that are located in both the eastern United States and western United States, with 2 data centers in the eastern United states and 4 data centers in the western United States.

“Node” generally refers to an individual computing device that is a part of a cluster. A node may join with one or more other nodes to form a cluster. One or nodes that comprise a cluster may store data (e.g., tables, indexes, etc.) in a map of KV pairs. A node may store a “range”, which can be a subset of the KV pairs (or all of the KV pairs depending on the size of the range) stored by the cluster. A range may also be referred to as a “shard” and/or a “partition”. A table and its secondary indexes can be mapped to one or more ranges, where each KV pair in a range may represent a single row in the table (which can also be referred to as the primary index because the table is sorted by the primary key) or a single row in a secondary index. Based on the range reaching or exceeding a threshold storage size, the range may split into two ranges. For example, based on reaching 512 mebibytes (MiB) in size, the range may split into two ranges. Successive ranges may split into one or more ranges based on reaching or exceeding a threshold storage size.

“Index” generally refers to a copy of the rows corresponding to a single table, where the rows are sorted by one or more columns (e.g., a column or a set of columns) of the table. Each index may correspond and/or otherwise belong to a single table. In some cases, an index may include a type. An example of a first type of index may be a primary index. A primary index may be an index on row-identifying primary key columns. A primary key constraint may be applied to one or more columns of a table to uniquely identify each row of the table, such that the primary key adds structure to table data. For a column configured with a primary key constraint, values stored in the column(s) must uniquely identify each row. One or more columns of a table may be configured with a primary key constraint and the database that includes the table may automatically create an index (referred to as a primary index) for the primary key column(s). A primary key may be defined for each table stored by a database as described herein. An example of a second type of index may be a secondary index. A secondary index may be defined on non-primary key columns of a table. A table that does not include a defined primary index may include a hidden row identifier (ID) column (e.g., referred to as rowid) that uniquely identifies each row of the table as an implicit primary index.

“Replica” generally refers to a copy of a range. A range may be replicated at least a threshold number of times to produce a number of replicas. For example and by default, a range may be replicated 3 times as 3 distinct replicas. Each replica of a range may be stored on a distinct node of a cluster. For example, 3 replicas of a range may each be stored on a different node of a cluster. In some cases, a range may be required to be replicated a minimum of 3 times to produce at least 3 replicas.

“Leaseholder” or “leaseholder replica” generally refers to a replica of a range that is configured to hold the lease for the replicas of the range. The leaseholder may receive and/or coordinate read transactions and write transactions directed to one or more KV pairs stored by the range. “Leaseholder node” may generally refer to the node of the cluster that stores the leaseholder replica. The leaseholder may receive read transactions and serve reads to client devices indicated by the read transactions. Other replicas of the range that are not the leaseholder may receive read transactions and route the read transactions to the leaseholder, such that the leaseholder can serve the read based on the read transaction.

“Raft leader” or “leader” generally refers to a replica of the range that is a leader for managing write transactions for a range. In some cases, the leader and the leaseholder are the same replica for a range (e.g., leader is inclusive of leaseholder and/or leaseholder is inclusive of leader). In other cases, the leader and the leaseholder are not the same replica for a range. “Raft leader node” or “leader node” generally refers to a node of the cluster that stores the leader. The leader may determine that a threshold number of the replicas of a range agree to commit a write transaction prior to committing the write transaction. In some cases, the threshold number of the replicas of the range may be a majority of the replicas of the range.

“Follower” generally refers to a replica of the range that is not the leader. “Follower node” may generally refer to a node of the cluster that stores the follower replica. Follower replicas may receive write transactions from the leader replica. The leader replica and the follower replicas of a range may constitute voting replicas that participate in a distributed consensus protocol and included operations (also referred to as “Raft protocol” and “Raft operations” as described herein.

“Raft log” generally refers to a time-ordered log of write transactions to a range, where the log of write transactions includes write transactions agreed to by a threshold number of the replicas of the range. Each replica of a range may include a raft log stored on the node that stores the replica. The raft log for a replica may be stored on persistent storage (e.g., non-volatile storage such as disk storage, solid state drive (SSD) storage, etc.) of the node storing the replica. A raft log may be a source of truth for replication among nodes for a range.

“Consistency” generally refers to causality and the ordering of transactions within a distributed system. Consistency defines rules for operations within the distributed system, such that data stored by the system will remain consistent with respect to read and write operations originating from different sources.

“Consensus” generally refers to a threshold number of replicas for a range, based on receiving a write transaction, acknowledging a write transaction. In some cases, the threshold number of replicas may be a majority of replicas for a range. Consensus may be achieved even if one or more nodes storing replicas of a range are offline, such that the threshold number of replicas for the range can acknowledge the write transaction. Based on achieving consensus, data modified by the write transaction may be stored within the range(s) targeted by the write transaction.

“Replication” generally refers to creating and distributing copies (e.g., replicas) of the data stored by the cluster. In some cases, replication can ensure that replicas of a range remain consistent among the nodes that each comprise a replica of the range. In some cases, replication may be synchronous such that write transactions are acknowledged and/or otherwise propagated to a threshold number of replicas of a range before being considered committed to the range.

### Database Overview

A database stored by a cluster of nodes may operate based on one or more remote procedure calls (RPCs). The database may be comprised of a KV store distributed among the nodes of the cluster. In some cases, the RPCs may be SQL RPCs. In other cases, RPCs based on other programming languages may be used. Nodes of the cluster may receive SQL RPCs from client devices. After receiving SQL RPCs, nodes may convert the SQL RPCs into operations that may operate on the distributed KV store.

In some embodiments, as described herein, the KV store of the database may be comprised of one or more ranges. A range may be a selected storage size. For example, a range may be 512 MiB. Each range may be replicated to more than one node to maintain data survivability. For example, each range may be replicated to at least 3 nodes. By replicating each range to more than one node, if a node fails, replica(s) of the range would still exist on and be available on other nodes such that the range can still be accessed by client devices and replicated to other nodes of the cluster.

In some embodiments, operations directed to KV data as described herein may be executed by one or more transactions. In some cases, a node may receive a read transaction from a client device. A node may receive a write transaction from a client device. In some cases, a node can receive a read transaction or a write transaction from another node of the cluster. For example, a leaseholder node may receive a read transaction from a node that originally received the read transaction from a client device. In some cases, a node can send a read transaction to another node of the cluster. For example, a node that received a read transaction, but cannot serve the read transaction may send the read transaction to the leaseholder node. In some cases, if a node receives a read or write transaction that it cannot directly serve, the node may send and/or otherwise route the transaction to the node that can serve the transaction.

In some embodiments, modifications to the data of a range may rely on a consensus protocol to ensure a threshold number of replicas of the range agree to commit the change. The threshold may be a majority of the replicas of the range. The consensus protocol may enable consistent reads of data stored by a range.

In some embodiments, data may be written to and/or read from a storage device of a node using a storage engine that tracks the timestamp associated with the data. By tracking the timestamp associated with the data, client devices may query for historical data from a specific period of time (e.g., at a specific timestamp). A timestamp associated with a key corresponding to KV data may be assigned by a gateway node that received the transaction that wrote and/or otherwise modified the key. For a transaction that wrote and/or modified the respective key, the gateway node (e.g., the node that initially receives a transaction) may determine and assign a timestamp to the transaction based on time of a clock of the node. The transaction may assign the timestamp to the KVs that are subject to the transaction. Timestamps may enable tracking of versions of KVs (e.g., through multi-version concurrency control (MVCC) as to be described herein) and may provide guaranteed transactional isolation. In some cases, additional or alternative methods may be used to assign versions and/or timestamps to keys and respective values.

In some embodiments, a “table descriptor” may correspond to each table of the database, where the table descriptor may contain the schema of the table and may include information associated with the table. Each table descriptor may be stored in a “descriptor table”, where each version of a table descriptor may be accessed by nodes of a cluster. In some cases, a “descriptor” may correspond to any suitable schema or subset of a schema, where the descriptor may contain the schema or the subset of the schema and may include information associated with the schema (e.g., a state of the schema). Examples of a descriptor may include a table descriptor, type descriptor, database descriptor, and schema descriptor. A view and/or a sequence as described herein may correspond to a table descriptor. Each descriptor may be stored by nodes of a cluster in a normalized or a denormalized form. Each descriptor may be stored in a KV store by nodes of a cluster. In some embodiments, the contents of a descriptor may be encoded as rows in a database (e.g., SQL database) stored by nodes of a cluster. Descriptions for a table descriptor corresponding to a table may be adapted for any suitable descriptor corresponding to any suitable schema (e.g., user-defined schema) or schema element as described herein. In some cases, a database descriptor of a database may include indications of a primary region and one or more other database regions configured for the database.

In some embodiments, database architecture for the cluster of nodes may be comprised of one or more layers. The one or more layers may process received SQL RPCs into actionable processes to access, modify, store, and return data to client devices, while providing for data replication and consistency among nodes of a cluster. The layers may comprise one or more of: a SQL layer, a transactional layer, a distribution layer, a replication layer, and a storage layer.

In some cases, the SQL layer of the database architecture exposes a SQL application programming interface (API) to developers and converts high-level SQL statements into low-level read and write requests to the underlying KV store, which are passed to the transaction layer. The transaction layer of the database architecture can implement support for atomic, consistent, isolated, and durable (ACID) transactions by coordinating concurrent operations. Additional features of the transaction layer are described herein with respect to “Transaction Layer”. The distribution layer of the database architecture can provide a unified view of a cluster's data. The replication layer of the database architecture can copy data between nodes and ensure consistency between these copies by implementing a consensus algorithm. The storage layer may commit writes from the Raft log to disk (e.g., a computer-readable storage medium on a node), as well as return requested data (e.g., read data) to the replication layer.

### Transaction Layer

In some embodiments, the database architecture for a database stored by a cluster (e.g., cluster 102) of nodes may include a transaction layer. The transaction layer may enable atomicity, consistency, isolation, and durability (ACID) semantics for transactions within the database. The transaction layer may receive binary KV operations from the SQL layer and control KV operations sent to a distribution layer. In some cases, a storage layer of the database may use MVCC to maintain multiple versions of keys stored in ranges of the cluster. For example, each key stored in a range may have a stored MVCC history including respective versions of the key, values for the versions of the key, and/or timestamps at which the respective versions were written and/or committed.

In some embodiments, for write transactions, the transaction layer may generate one or more locks. A lock may represent a provisional, uncommitted state for a particular value of a KV pair. The lock may be written as part of the write transaction. The database architecture described herein may include multiple lock types. In some cases, the transactional layer may generate unreplicated locks, which may be stored in an in-memory lock table (e.g., stored by volatile, non-persistent storage of a node) that is specific to the node storing the replica on which the write transaction executes. An unreplicated lock may not be replicated other replicas based on a consensus protocol as described herein. In other cases, the transactional layer may generate one or more replicated locks (referred to as “intents” or “write intents”). An intent may be a persistent, provisional value written by a transaction before the transaction commits that is stored in persistent storage (e.g., non-volatile storage such as disk storage, SSD storage, etc.) of nodes of the cluster. Each KV write performed by a transaction is initially an intent, which includes a provisional version and a reference to the transaction's corresponding transaction record. An intent may differ from a committed value by including a pointer to a transaction record of a transaction that wrote the intent. In some cases, the intent functions as an exclusive lock on the KV data of the replica stored on the node on which the write transaction executes, thereby preventing conflicting read and write operations having timestamps greater than or equal to a timestamp corresponding to the intent (e.g., the timestamp assigned to the transaction when the intent was written). An intent may be replicated to other nodes of the cluster storing a replica of the range based on the consensus protocol as described herein. An intent for a particular key may be included in an MVCC history corresponding to the key, such that a reader of the key can distinguish the intent from other versions of committed MVCC values stored in persistent storage for the key.

In some embodiments, each transaction directed to the cluster may have a unique replicated KV pair (referred to as a “transaction record”) stored on a range stored by the cluster. The transaction for a record may be added and stored in a replica of a range on which a first operation of the write transaction occurs. The transaction record for a particular transaction may store metadata corresponding to the transaction. The metadata may include an indication of a status of a transaction and a unique identifier (ID) corresponding to the transaction. The status of a transaction may be one of: “pending” (also referred to as “PENDING”), staging (also referred to as “STAGING”), “committed” (also referred to as “COMMITTED”), or “aborted” (also referred to as “ABORTED”) as described herein. A pending state may indicate that the transaction is in progress. A staging state may be used to enable a parallel commit protocol as described further with respect to “Commit After Distributed Consensus”. A committed state may indicate that the transaction has committed and the write intents written by the transaction have been recorded by follower replicas. An aborted state may indicate the write transaction has been aborted and the values (e.g., values written to the range) associated with the write transaction may be discarded and/or otherwise dropped from the range. As write intents are generated by the transaction layer as a part of a write transaction, the transaction layer may check for newer (e.g., more recent) committed values at the KVs of the range on which the write transaction is operating. If newer committed values exist at the KVs of the range, the write transaction may be restarted. Alternatively, if the write transaction identifies write intents at the KVs of the range, the write transaction may proceed as a transaction conflict as to be described herein. The transaction record may be addressable using the transaction's unique ID, such that requests can query and read a transaction's record using the transaction's ID.

In some embodiments, for read transactions, the transaction layer may execute a read transaction at KVs of a range indicated by the read transaction. The transaction layer may execute the read transaction if the read transaction is not aborted. The read transaction may read MVCC values at the KVs of the range. Alternatively, the read transaction may read intents written at the KVs, such that the read transaction may proceed as a transaction conflict as to be described herein.

In some embodiments, to commit a write transaction, the transaction layer may determine the transaction record of the write transaction as it executes. The transaction layer may restart the write transaction based on determining the state of the write transaction indicated by the transaction record is aborted. Alternatively, the transaction layer may determine the transaction record to indicate the state as pending or staging. Based on the transaction record indicating the write transaction is in a pending state, the transaction layer may set the transaction record to staging and determine whether the write intents of the write transaction have succeeded (e.g., succeeded by replication to the other nodes storing the range). If the write intents have succeeded, the transaction layer may report the commit of the transaction to the client device that initiated the write transaction.

In some embodiments, based on committing a write transaction, the transaction layer may cleanup the committed write transaction. A coordinating node to which the write transaction was directed may cleanup the committed write transaction via the transaction layer. A coordinating node may be a node that stores a replica of a range that is the subject of the transaction. In some cases, a coordinating node may be the gateway node for the transaction. The coordinating node may track a record of the KVs that were the subject of the write transaction. To clean up the transaction, the coordinating node may modify the state of the transaction record for the write transaction from staging to committed. In some cases, the coordinating node may resolve the write intents of the write transaction to MVCC (e.g., committed) values by removing the pointer to the transaction record. Based on removing the pointer to the transaction record for the write transaction, the coordinating node may delete the write intents of the transaction. Based on the deletion of each of the write intents for the transaction, the transaction record may be deleted. Additional features of the parallel commit protocol are described with respect to “Commit After Distributed Consensus”.

In some embodiments, the transaction layer may track timing of transactions (e.g., to maintain serializability). The transaction layer may implement hybrid-logical clocks (HLCs) to track time within the cluster. An HLC may be composed of a physical component (e.g., which may be close to local actual time) and a logical component (e.g., which is used to distinguish between events with the same physical component). HLC time may always be greater than or be equal to the actual time. Each node may include a local HLC.

For a transaction, the gateway node (e.g., the node that initially receives a transaction) may determine a timestamp for the transaction and included operations based on HLC time for the node. The transaction layer may enable transaction timestamps based on HLC time. A timestamp within the cluster may be used to track versions of KVs (e.g., through MVCC as to be described herein) and provide guaranteed transactional isolation. A timestamp for a write intent as described herein may be equivalent to the assigned timestamp of a transaction corresponding to the write intent when the write intent was written to storage. A timestamp for a write intent corresponding to a transaction may be less than or equal to a commit timestamp for a transaction. When a timestamp for a write intent is less than a commit timestamp for the transaction that wrote the write intent (e.g., based on advancing the commit timestamp due to a transaction conflict or a most-recent timestamp indicated by a timestamp cache), during asynchronous intent resolution, the committed, MVCC version of the write intent may have its respective timestamp advanced to be equivalent to the commit timestamp of the transaction.

For a transaction, based on a node sending a transaction to another node, the node may include the timestamp generated by the local HLC (e.g., the HLC of the node) with the transaction. Based on receiving a request from another node (e.g., sender node), a node (e.g., receiver node) may inform the local HLC of the timestamp supplied with the transaction by the sender node. In some cases, the receiver node may update the local HLC of the receiver node with the timestamp included in the received transaction. Such a process may ensure that all data read and/or written to a node has a timestamp less than the HLC time at the node. Accordingly, the leaseholder for a range may serve reads for data stored by the leaseholder, where the read transaction that reads the data includes an HLC timestamp greater than HLC timestamp of the MVCC value read by the read transaction (e.g., such that the read occurs after the write).

To provide serializability within the cluster, based on a transaction reading a value of a range, the transaction layer may store the transaction operation's timestamp in a timestamp cache stored at the leaseholder replica of the range. For each read operation directed to a range, the timestamp cache may record and include an indication of the latest timestamp (e.g., the timestamp that is the furthest ahead in time) at which value(s) of the range that were read by a read operation of a transaction. Based on execution of a write transaction, the transaction layer may compare the timestamp of the write transaction to the latest timestamp indicated by the timestamp cache. If the timestamp of the write transaction is less than the latest timestamp indicated by the timestamp cache, the transaction layer may attempt to advance the timestamp of the write transaction forward to a later timestamp. In some cases, advancing the timestamp may cause the write transaction to restart in the second phase of the transaction as to be described herein with respect to read refreshing.

As described herein, the SQL layer may convert SQL statements (e.g., received from client devices) to KV operations. KV operations generated from the SQL layer may use a Client Transaction (CT) transactional interface of the transaction layer to interact with the KVs stored by the cluster. The CT transactional interface may include a transaction coordinator. The transaction coordinator may perform one or more operations as a part of the transaction layer. Based on the execution of a transaction, the transaction coordinator may send (e.g., periodically send) “heartbeat” messages to a transaction record for the transaction. These messages may indicate that the transaction should keep executing (e.g., be kept alive). If the transaction coordinator fails to send the “heartbeat” messages, the transaction layer may modify the transaction record for the transaction to an aborted status. The transaction coordinator may track each written KV and/or KV range during the course of a transaction. In some embodiments, the transaction coordinator may clean and/or otherwise clear accumulated transaction operations. The transaction coordinator may clear an accumulated write intent for a write transaction based on the status of the transaction changing to committed or aborted.

As described herein, to track the status of a transaction during execution, the transaction layer writes to a transaction record corresponding to the transaction. Write intents of the transaction may route conflicting transactions to the transaction record based on the pointer to the transaction record included in the write intents, such that the conflicting transaction may determine a status for conflicting write intents as indicated in the transaction record. The transaction layer may write a transaction record to the same range as the first key subject to a transaction. The transaction coordinator may track the first key subject to a transaction. In some cases, the transaction layer may generate the transaction record when one of the following occurs: the write operation commits; the transaction coordinator sends heartbeat messages for the transaction; or an operation forces the transaction to abort. As described herein, a transaction record may have one of the following states: pending, committed, staging, or aborted. In some cases, the transaction record may not exist. If a transaction encounters a write intent where a transaction record corresponding to the write intent does not exist, the transaction may use the timestamp of the write intent to determine how to proceed with respect to the observed write intent. If the timestamp of the write intent is within a transaction liveness threshold, the write intent may be treated as pending. If the timestamp of the write intent is not within the transaction liveness threshold, the write intent may be treated as aborted. A transaction liveness threshold may be a duration configured based on a time period for sending “heartbeat” messages. For example, the transaction liveness threshold may be a duration lasting for five “heartbeat” message time periods, such that after five missed heartbeat messages, a transaction may be aborted. The transaction record for a committed transaction may remain until each of the write intents of the transaction are converted to committed MVCC values stored on persistent storage of a node.

As described herein, in the transaction layer, values may not be written directly to the storage layer as committed MVCC values during a write transaction. Values may be written in a provisional (e.g., uncommitted) state referred to as a write intent. Write intents may be MVCC values including a pointer to a transaction record to which the MVCC value belongs. Based on interacting with a write intent (instead of a committed MVCC value), an operation may determine the status of the transaction record, such that the operation may determine how to interpret the write intent. As described herein, if a transaction record is not found for a write intent, the operation may determine the timestamp of the write intent to evaluate whether or not the write intent may be considered to be expired.

In some embodiments, the transaction layer may include a concurrency manager for concurrency control. The concurrency manager may sequence incoming requests (e.g., from transactions) and may provide isolation between the transactions that issued those requests that intend to perform conflicting operations. This activity may be referred to as concurrency control. The concurrency manager may combine the operations of a latch manager and a lock table to accomplish this work. The latch manager may sequence the incoming requests and may provide isolation between those requests. The lock table may provide locking and sequencing of requests (in combination with the latch manager). The lock table may be a per-node, in-memory (e.g., stored by volatile, non-persistent storage) data structure. The lock table may hold a collection of locks acquired by transactions that are in-progress as to be described herein.

As described herein, the concurrency manager may be a structure that sequences incoming requests and provides isolation between the transactions that issued those requests, where the requests intend to perform conflicting operations. During sequencing, the concurrency manager may identify conflicts. The concurrency manager may resolve conflicts based on passive queuing and/or active pushing. Once a request has been sequenced by the concurrency manager, the request may execute (e.g., without other conflicting requests/operations) based on the isolation provided by the concurrency manager. This isolation may last for the duration of the request. The isolation may terminate based on (e.g., after) completion of the request. Each request in a transaction may be isolated from other requests. Each request may be isolated during the duration of the request, after the request has completed (e.g., based on the request acquiring locks), and/or within the duration of the transaction comprising the request. The concurrency manager may allow transactional requests (e.g., requests originating from transactions) to acquire locks, where the locks may exist for durations longer than the duration of the requests themselves. The locks may extend the duration of the isolation provided over specific keys stored by the cluster to the duration of the transaction. The locks may be released when the transaction commits or aborts. Other requests that encounter and/or otherwise interact with the locks (e.g., while being sequenced) may wait in a queue for the locks to be released. Based on the locks being released, the other requests may proceed. The concurrency manager may include information for external locks (e.g., the write intents).

In some embodiments, one or more locks may not be controlled by the concurrency manager, such that one or more locks may not be discovered during sequencing. As an example, write intents (e.g., replicated, exclusive locks) may be stored such that that may not be detected until request evaluation time. In most embodiments, fairness may be ensured between requests, such that if any two requests conflict, the request that arrived first will be sequenced first. Sequencing may guarantee first-in, first-out (FIFO) semantics. An exception to FIFO semantics is that a request that is part of a transaction which has already acquired a lock may not need to wait on that lock during sequencing. The request may disregard any queue that has formed on the lock. Lock tables as to be described herein may include one or more other exceptions to the FIFO semantics described herein.

In some embodiments, as described herein, a lock table may be a per-node, in-memory data structure. The lock table may store a collection of locks acquired by in-progress transactions. Each lock in the lock table may have an associated lock wait-queue. Conflicting transactions can queue in the associated lock wait-queue based on waiting for the lock to be released. Items in the locally stored lock wait-queue may be propagated as necessary (e.g., via RPC) to an existing Transaction Wait Queue (TWQ). The TWQ may be stored on the leader replica of the range, where the leader replica on which the first write operation of a transaction occurred may contain the transaction record.

As described herein, databases stored by the cluster may be read and written using one or more “requests”. A transaction may be composed of one or more requests. Isolation may be needed to separate requests. Additionally, isolation may be needed to separate transactions. Isolation for requests and/or transactions may be accomplished by maintaining multiple versions and/or by allowing requests to acquire locks. Isolation based on multiple versions may require a form of mutual exclusion, such that a read and a conflicting lock acquisition do not occur concurrently. The lock table may provide locking and/or sequencing of requests (in combination with the use of latches).

In some embodiments, locks may last for a longer duration than the requests associated with the locks. Locks may extend the duration of the isolation provided over specific KVs to the duration of the transaction associated with the lock. As described herein, locks may be released when the transaction commits or aborts. Other requests that encounter and/or otherwise interact with the locks (e.g., while being sequenced) may wait in a queue for the locks to be released. Based on the locks being released, the other requests may proceed. In some embodiments, the lock table may enable fairness between requests, such that if two requests conflict, then the request that arrived first may be sequenced first. In some cases, there may be exceptions to the FIFO semantics as described herein. A request that is part of a transaction that has acquired a lock may not need to wait on that lock during sequencing, such that the request may ignore a queue that has formed on the lock. In some embodiments, contending requests that encounter different levels of contention may be sequenced in a non-FIFO order. Such sequencing in a non-FIFO order may enable greater concurrency. As an example, if requests R₁ and R₂ contend on key K₂, but R₁ is also waiting at key K₁, R₂ may be determined to have priority over R₁, such that R₂ may be executed on K₂.

In some embodiments, as described herein, a latch manager may sequence incoming requests and may provide isolation between those requests. The latch manager may sequence and provide isolation to requests under the supervision of the concurrency manager. A latch manager may operate as follows. As write requests occur for a range, a leaseholder of the range may serialize write requests for the range. Serializing the requests may group the requests into a consistent order. To enforce the serialization, the leaseholder may create a “latch” for the keys in the write value, such that a write request may be given uncontested access to the keys. If other requests access the leaseholder for the same set of keys as the previous write request, the other requests may wait for the latch to be released before proceeding. In some cases, read requests may generate latches. Multiple read latches over the same keys may be held concurrently. A read latch and a write latch over the same keys may not be held concurrently.

In some embodiments, the transaction layer may execute transactions at a serializable transaction isolation level. A serializable isolation level may not prevent anomalies in data stored by the cluster. A serializable isolation level may be enforced by requiring the client device to retry transactions if serializability violations are possible.

In some embodiments, the transaction layer may allow for one or more transaction conflict types, where a conflict type may result from a transaction encountering and/or otherwise interacting with a write intent at a key (e.g., at least one key). A write/write transaction conflict may occur when two pending transactions create write intents for the same key. A write/read transaction conflict may occur when a read transaction encounters an existing write intent with a timestamp less than or equal to the timestamp of the read transaction. To resolve the transaction conflict, the transaction layer may proceed through one or more operations. Based on a transaction within the transaction conflict having a defined transaction priority (e.g., high priority, low priority, etc.), the transaction layer may abort the transaction with lower priority (e.g., in a write/write conflict) or advance the timestamp of the transaction having a lower priority (e.g., in a write/read conflict). Based on a transaction within the conflicting transactions being expired, the expired transaction may be aborted. A transaction may be considered to be expired if the transaction does not have a transaction record or the timestamp for the transaction is outside of the transaction liveness threshold. A transaction may be considered to be expired if the transaction record corresponding to the transaction has not received a “heartbeat” message from the transaction coordinator within the transaction liveness threshold. A transaction (e.g., a low priority transaction) that is required to wait on a conflicting transaction may enter the TWQ as described herein.

In some embodiments, the transaction layer may allow for one or more additional conflict types that do not involve write intents. A write after read conflict may occur when a write transaction having a lower timestamp conflicts with a read transaction having a higher timestamp. The timestamp of the write transaction may advance past the timestamp of the read transaction, such that the write transaction may execute. A read within an uncertainty window may occur when a read transaction encounters a KV with a higher timestamp and there exists ambiguity whether the KV should be considered to be in the future or in the past of the read transaction. An uncertainty window may be configured based on the maximum allowed offset between the clocks (e.g., HLCs) of any two nodes within the cluster. In an example, the uncertainty window may be equivalent to the maximum allowed offset. A read within an uncertainty window may occur based on clock skew. The transaction layer may advance the timestamp of the read transaction past the timestamp of the KV according to read refreshing as to be described herein. If the read transaction associated with a read within an uncertainty window has to be restarted, the read transaction may never encounter an uncertainty window on any node which was previously visited by the read transaction. In some cases, there may not exist an uncertainty window for KVs read from the gateway node of the read transaction.

In some embodiments, as described herein, the TWQ may track all transactions that could not advance another blocking, ongoing transaction that wrote write intents observed by the tracked transactions. The transactions tracked by the TWQ may be queued and may wait for the blocking transaction to complete before the transaction can proceed to execute. The structure of the TWQ may map a blocking transaction to the one or more other transactions that are blocked by the blocking transaction via the respective unique IDs corresponding to each of the transactions. The TWQ may operate on the leader replica of a range, where the leader replica includes the transaction record based on being subject to the first write operation included in the blocking, ongoing transaction. Based on a blocking transaction resolving (e.g., by committing or aborting), an indication may be sent to the TWQ that indicates the queued transactions blocked by the blocking transaction may begin to execute. A blocked transaction (e.g., a transaction blocked by a blocking transaction) may examine their transaction status to determine whether they are active. If the transaction status for the blocked transaction indicates the blocked transaction is aborted, the blocked transaction may be removed by the transaction layer. In some cases, deadlock may occur between transactions, where a first transaction may be blocked by second write intents of a second transaction and the second transaction may be blocked by first write intents of the first transaction. If transactions are deadlocked (e.g., blocked on write intents of another transaction), one transaction of the deadlocked transactions may randomly abort, such that the active (e.g., alive) transaction may execute and the deadlock may be removed. A deadlock detection mechanism may identify whether transactions are deadlocked and may cause one of the deadlocked transactions to abort.

In some embodiments, the transaction layer may enable read refreshing. When a timestamp of a transaction has been advanced to a later timestamp, additional considerations may be required before the transaction may commit at the advanced timestamp. The considerations may include checking KVs previously read by the transaction to verify that other write transactions have not occurred at the KVs between the original transaction timestamp and the advanced transaction timestamp. This consideration may prevent serializability violations. The check may be executed by tracking each read using a Refresh Request (RR). If the check succeeds (e.g., write transactions have not occurred between the original transaction timestamp and the advanced transaction timestamp), the transaction may be allowed to commit at the advanced timestamp. A transaction may perform the check at a commit time if the transaction was advanced by a different transaction or by the timestamp cache. A transaction may perform the check based on encountering a read within an uncertainty interval. If the check is unsuccessful, then the transaction may be retried at the advanced timestamp.

In some embodiments, the transaction layer may enable transaction pipelining. Write transactions may be pipelined when being replicated to follower replicas and when being written to storage. Transaction pipelining may reduce the latency of transactions that perform multiple writes. In transaction pipelining, write intents may be replicated from leaseholders (e.g., combined leaseholder and leader replicas) to follower replicas in parallel, such that waiting for a commit occurs at transaction commit time. Transaction pipelining may include one or more operations. In transaction pipelining, for each received statement (e.g., operation) of a transaction, the gateway node corresponding to the transaction may communicate with the leaseholders (L₁, L₂, L₃, . . . , Lᵢ) for the range(s) indicated by the transaction. Each leaseholder Lᵢ may receive the communication from the gateway node and may perform one or more operations in parallel. Each leaseholder Lᵢ may (i) create write intents, and (ii) send the write intents to corresponding follower nodes for the leaseholder Lᵢ. After sending the write intents to the corresponding follower nodes, each leaseholder Lᵢ may send an indication to the gateway node that the write intents have been sent. Replication of the intents may be referred to as “in-flight” once the leaseholder Lᵢ sends the write intents to the follower replicas. Before committing the transaction (e.g., by updating the transaction record for the transaction via a transaction coordinator), the gateway node may wait for the write intents to be replicated in parallel to each of the follower nodes of the leaseholders. Based on receiving responses from the leaseholders that the write intents have propagated to the follower nodes, the gateway node may commit the transaction by causing an update to the status of the transaction record of the transaction. Additional features of distributed consensus (e.g., Raft) operations are described with respect to “Transaction Execution”.

### Storage Layer

In some embodiments, the database architecture for the cluster may include a storage layer. The storage layer may enable the cluster to read and write data to storage device(s) of each node. As described herein, data may be stored as KV pairs on the storage device(s) using a storage engine. In some cases, the storage engine may be a Pebble storage engine. The storage layer may serve successful read transactions and write transactions from the replication layer.

In some embodiments, each node of the cluster may include at least one store, which may be specified when a node is activated and/or otherwise added to a cluster. Read transactions and write transactions may be processed from the store. Each store may contain two instances of the storage engine as described herein. A first instance of the storage engine may store temporary distributed SQL data. A second instance of the storage engine may store data other than the temporary distributed SQL data, including system data (e.g., meta ranges) and user data (e.g., table data, client data, etc.). For each node, a block cache may be shared between each store of the node. The store(s) of a node may store a collection of replicas of a range as described herein, where a particular replica may not be replicated among stores of the same node (or the same node), such that a replica may only exist once at a node.

In some embodiments, as described herein, the storage layer may use an embedded KV data store (e.g., Pebble). The KV data store may be used with an application programming interface (API) to read and write data to storage devices (e.g., persistent storage devices) of nodes of the cluster. The KV data store may enable atomic write batches and snapshots.

In some embodiments, the storage layer may use MVCC to enable concurrent requests. In some cases, the use of MVCC by the storage layer may guarantee consistency for the cluster. As described herein, HLC timestamps may be used to differentiate between different versions of data by tracking commit timestamps for data. HLC timestamps may be used to identify a garbage collection expiration for a value as to be described herein. In some cases, the storage layer may support time travel queries (e.g., queries directed to MVCC versions of keys at previous timestamps). Time travel queries may be enabled by MVCC versions of keys.

In some embodiments, the storage layer may aggregate MVCC values (e.g., garbage collect MVCC values) to reduce the storage size of the data stored by the storage (e.g., the disk) of nodes. The storage layer may compact MVCC values (e.g., old MVCC values) based on the existence of a newer MVCC value with a timestamp that is older than a garbage collection period. A garbage collection period may be configured for the cluster, database, and/or table. Garbage collection may be executed for MVCC values that are not configured with a protected timestamp. A protected timestamp subsystem may ensure safety for operations that rely on historical data. Operations that may rely on historical data may include imports, backups, streaming data using change feeds, and/or online schema changes. Protected timestamps may operate based on generation of protection records by the storage layer. Protection records may be stored in an internal system table. In an example, a long-running job (e.g., such as a backup) may protect data at a certain timestamp from being garbage collected by generating a protection record associated with that data and timestamp. Based on successful creation of a protection record, the MVCC values for the specified data at timestamps less than or equal to the protected timestamp may not be garbage collected. When the job (e.g., the backup) that generated the protection record is complete, the job may remove the protection record from the data. Based on removal of the protection record, the garbage collector may operate on the formerly protected data.

### Database Architecture

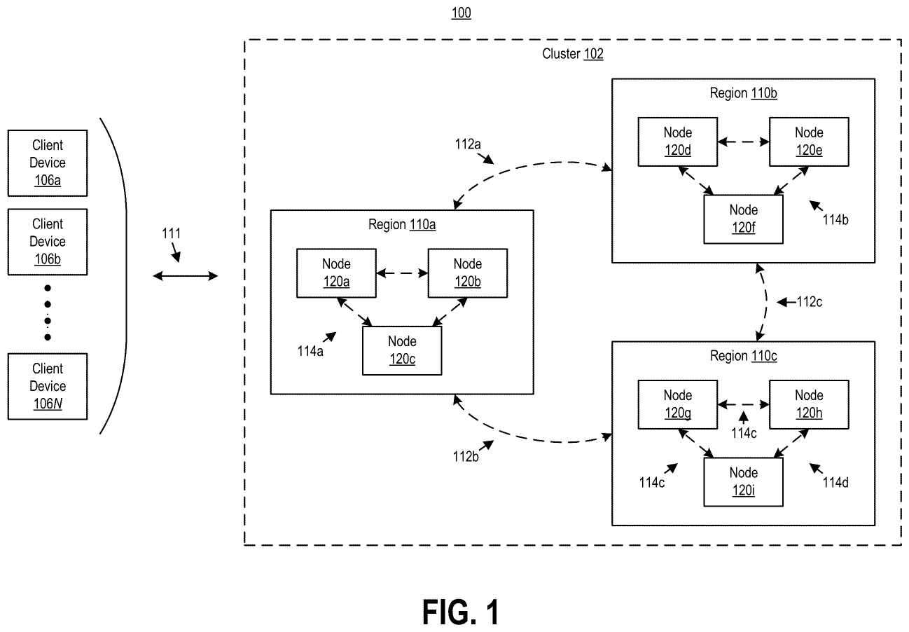

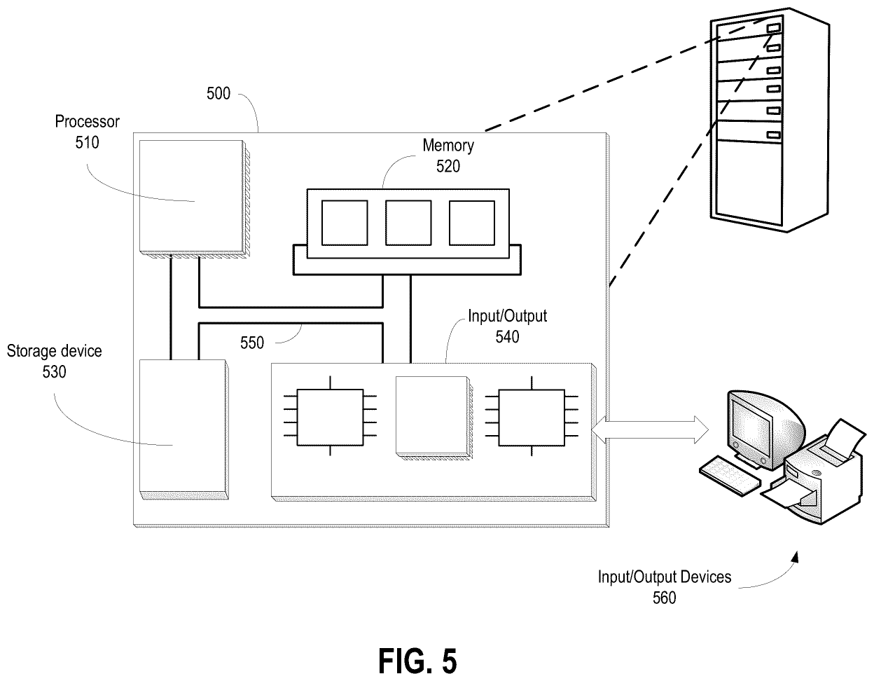

Referring to FIG. 1, an illustrative distributed computing system 100 is presented. The computing system 100 may include a cluster 102. In some cases, the computing system may include one or more additional clusters 102. The cluster 102 may include one or more nodes 120 distributed among one or more geographic regions 110. The geographic regions 110 may correspond to cluster regions and database regions as described further below. A node 120 may be a computing device. In some cases, a node 120 may include at least portions of the computing system as described herein with respect to FIG. 5. As an example, a node 120 may be a server computing device. A region 110 may correspond to a particular building (e.g., a data center), city, state/province, country, geographic region, and/or a subset of any one of the above. A region 110 may include multiple elements, such as a country and a geographic identifier for the country. For example, a region 110 may be indicated by Country=United States and Region=Central, which may indicate a region 110 as the Central United States. As shown in FIG. 1, the cluster 102 may include regions 110a, 110b, and 110c. In some cases, the cluster 102 may include one region 110. In an example, the region 110a may be the Eastern United States, the region 110b may be the Central United States, and the region 110c may be the Western United States. Each region 110 of the cluster 102 may include one or more nodes 120. In some cases, a region 110 may not include any nodes 120. The region 110a may include nodes 120a, 120b, and 120c. The region 110b may include the nodes 120d, 120e, and 120f. The region 110c may include nodes 120g, 120h, and 120i.

Each node 120 of the cluster 102 may be communicatively coupled via one or more networks 112 and 114. In some cases, the cluster 102 may include networks 112a, 112b, and 112c, as well as networks 114a, 114b, 114c, and 114d. The networks 112 may include a local area network (LAN), wide area network (WAN), and/or any other suitable network. In some cases, the one or more networks 112 may connect nodes 120 of different regions 110. The nodes 120 of region 110a may be connected to the nodes 120 of region 110b via a network 112a. The nodes 120 of region 110a may be connected to the nodes 120 of region 110c via a network 112b. The nodes 120 of region 110b may be connected to the nodes 120 of region 110c via a network 112c. The networks 114 may include a LAN, WAN, and/or any other suitable network. In some cases, the networks 114 may connect nodes 120 within a region 110. The nodes 120a, 120b, and 120c of the region 110a may be interconnected via a network 114a. The nodes 120d, 120e, and 120f of the region 110b may be interconnected via a network 114b. In some cases, the nodes 120 within a region 110 may be connected via one or more different networks 114. The node 120g of the region 110c may be connected to nodes 120h and 120i via a network 114c, while nodes 120h and 120i may be connected via a network 114d. In some cases, the nodes 120 of a region 110 may be located in different geographic locations within the region 110. For example, if region 110a is the Eastern United States, nodes 120a and 120b may be located in New York, while node 120c may be located in Massachusetts.

In some embodiments, the computing system 100 may include one or more client devices 106. The one or more client devices 106 may include one or more computing devices. In some cases, the one or more client devices 106 may each include at least portions of the computing system as described herein with respect to FIG. 5. In an example, the one or more client devices 106 may include laptop computing devices, desktop computing devices, mobile computing devices, tablet computing devices, and/or server computing device. As shown in FIG. 1, the computing system 100 may include client devices 106a, 106b, and one or more client devices 106 up to client device 106N, where N is any suitable number of client devices 106 included in the computing system 100. The client devices 106 may be communicatively coupled to the cluster 102, such that the client devices 106 may access and/or otherwise communicate with the nodes 120. One or more networks 111 may couple the client devices 106 the nodes 120. The one or more networks 111 may include a LAN, a WAN, and/or any other suitable network as described herein. As an example, the client devices 106 may communicate with the nodes 120 via a SQL client operating at each respective client device 106. To access and/or otherwise interact with the data stored by the cluster 102, a client device 106 may communicate with a gateway node, which may be a node 120 of the cluster that is closest (e.g., by latency, geographic proximity, and/or any other suitable indication of closeness) to the client device 106. The gateway node may route communications between a client device 106 and any other node 120 of the cluster.

### Transaction Execution

In some embodiments, as described herein, distributed transactional databases stored by the cluster of nodes may enable one or more transactions. Each transaction may include one or more requests (e.g., queries) directed to performing one or more operations. In some cases, a request may be a query (e.g., a SQL query). A request may traverse one or more nodes of a cluster to execute the request. A request may interact with (e.g., sequentially interact with) one or more of the following: a SQL client, a load balancer, a gateway, a leaseholder, and/or a Raft Leader as described herein. A SQL client may send a request (e.g., query) to a cluster. The request may be included in a transaction, where the transaction is a read and/or a write transaction as described herein. A load balancer may route the request from the SQL client to the nodes of the cluster. A gateway node may be a node that initially receives the request and/or sends a response to the SQL client. A leaseholder may be a node that serves reads and coordinates writes for a range of keys (e.g., keys indicated in the request) as described herein. A Raft leader may be a node that maintains consensus among the replicas for a range.

A SQL client (e.g., operating at a client device 106a) may send a request (e.g., a SQL request) to a cluster (e.g., cluster 102). The request may be sent over a network (e.g., the network 111). A load balancer may determine a node of the cluster to which to send the request. The node may be a node of the cluster having the lowest latency and/or having the closest geographic location to the computing device on which the SQL client is operating. A gateway node (e.g., node 120a) may receive the request from the load balancer. The gateway node may parse the request to determine whether the request is valid. The request may be valid based on conforming to the syntax (e.g., SQL syntax) of the database(s) stored by the cluster. An optimizer operating at the gateway node may generate a number of logically equivalent query plans based on the received request. Each query plan may correspond to a physical operation tree configured to be executed for the query. The optimizer may select an optimal query plan from the number of query plans (e.g., based on a cost model). Based on the completion of request planning, a query execution engine may execute the selected, optimal query plan using a transaction coordinator as described herein. A transaction coordinator operating on a gateway node may perform one or more operations as a part of the transaction layer. The transaction coordinator may perform KV operations on a database stored by the cluster. The transaction coordinator may account for keys indicated and/or otherwise involved in a transaction. The transaction coordinator may package KV operations into a Batch Request as described herein, where the Batch Request may be forwarded on to a Distribution Sender (DistSender) operating on the gateway node.

A DistSender of a gateway node and/or coordinating node may receive Batch Requests from a transaction coordinator of the same node. The DistSender of the gateway node may receive the Batch Request from the transaction coordinator. The DistSender may determine the operations indicated by the Batch Request and may determine the node(s) (i.e. the leaseholder node(s)) that should receive requests corresponding to the operations for the range. The DistSender may generate one or more Batch Requests based on determining the operations and the node(s) as described herein. The DistSender may send a first Batch Request for each range in parallel. Based on receiving a provisional acknowledgment from a leaseholder node's evaluator, the DistSender may send the next Batch Request for the range corresponding to the provisional acknowledgement. The DistSender may wait to receive acknowledgments for write operations and values for read operations corresponding to the sent Batch Requests.

As described herein, the DistSender of the gateway node may send Batch Requests to leaseholders (or other replicas) for data indicated by the Batch Request. In some cases, the DistSender may send Batch Requests to nodes that are not the leaseholder for the range (e.g., based on out of date leaseholder information). Nodes may or may not store the replica indicated by the Batch Request. Nodes may respond to a Batch Request with one or more responses. A response may indicate the node is no longer a leaseholder for the range. The response may indicate the last known address of the leaseholder for the range. A response may indicate the node does not include a replica for the range. A response may indicate the Batch Request was successful if the node that received the Batch Request is the leaseholder. The leaseholder may process the Batch Request. As a part of processing of the Batch Request, each write operation in the Batch Request may compare a timestamp of the write operation to the timestamp cache. A timestamp cache may track the highest timestamp (i.e., most recent timestamp) for any read operation that a given range has served. The comparison may ensure that the write operation has a higher timestamp than any timestamp indicated by the timestamp cache. If a write operation has a lower timestamp than any timestamp indicated by the timestamp cache, the write operation may be restarted at an advanced timestamp that is greater than the value of the most recent timestamp indicated by the timestamp cache.

In some embodiments, operations indicated in the Batch Request may be serialized by a latch manager of a leaseholder. For serialization, each write operation may be given a latch on a row. Any read and/or write operations that arrive after the latch has been granted on the row may be required to wait for the write operation to complete. Based on completion of the write operation, the latch may be released and the subsequent operations can proceed to execute. In some cases, a batch evaluator may ensure that write operations are valid. The batch evaluator may determine whether the write operation is valid based on the leaseholder's data. The leaseholder's data may be evaluated by the batch evaluator based on the leaseholder coordinating writes to the range. If the batch evaluator determines the write operation to be valid, the leaseholder may send a provisional acknowledgement to the DistSender of the gateway node, such that the DistSender may begin to send subsequent Batch Requests for the range to the leaseholder.

In some embodiments, operations may read from the local instance of the storage engine as described herein to determine whether write intents are present at a key. If write intents are present at a particular key, an operation may resolve write intents as described herein. If the operation is a read operation and write intents are not present at the key, the read operation may read the value at the key of the leaseholder's storage engine. Read responses corresponding to a transaction may be aggregated into a Batch Response by the leaseholder. The Batch Response may be sent to the DistSender of the gateway node. If the operation is a write operation and write intents are not present at the key, the KV operations included in the Batch Request that correspond to the write operation may be converted to Raft (i.e. distributed consensus) operations and write intents, such that the write operation may be replicated to the replicas of the range.

With respect to a single round of distributed consensus, the leaseholder may propose the Raft operations to the leader replica of the Raft group (e.g., where the leader replica is typically also the leaseholder). Based on receiving the Raft operations, the leader replica may send the Raft operations to the follower replicas of the Raft group. Writing and/or execution of Raft operations as described herein may include writing one or more write intents to persistent storage. The leader replica and the follower replicas may attempt to write the Raft operations to their respective Raft logs. When a particular replica writes the Raft operations to its respective local Raft log, the replica may acknowledge success of the Raft operations by sending an indication of a success of writing the Raft operations to the leader replica. If a threshold number of the replicas acknowledge writing the Raft operations (e.g., the write operations) to their respective Raft log, consensus may be achieved such that the Raft operations may be committed (referred to as “consensus-committed” or “consensus-commit”). The consensus-commit may be achieved for a particular Raft operation when a majority of the replicas (e.g., including or not including the leader replica) have written the Raft operation to their local Raft log. The consensus-commit may be discovered or otherwise known to the leader replica to be committed when a majority of the replicas have sent an indication of success for the Raft operation to the leader replica. Based on a Raft operation (e.g., write operation) being consensus-committed among a Raft group, each replica included in the Raft group may apply the committed entry to their respective local state machine. Based on achieving consensus-commit among the Raft group, the Raft operations (e.g., write operations included in the write transaction) may be considered to be committed (e.g., implicitly committed as described herein). The gateway node may update the status of transaction record for the transaction corresponding to the Raft operations to committed (e.g., explicitly committed as described herein). A latency for the above-described distributed consensus round may be equivalent to a duration for sending a Raft operation from the leader replica to the follower replicas, receiving success responses for the Raft operation at the leader replica from at least some of the follower replicas (e.g., such that a majority of replicas write to their respective Raft log), and writing a write intent to persistent storage at the leader and follower replicas in parallel.

In some embodiments, based on the leader replica writing the Raft operations to the Raft log and receiving an indication of the consensus-commit among the Raft group, the leader replica may send a commit acknowledgement to the DistSender of the gateway node. The DistSender of the gateway node may aggregate commit acknowledgements from each write operation included in the Batch Request. In some cases, the DistSender of the gateway node may aggregate read values for each read operation included in the Batch Request. Based on completion of the operations of the Batch Request, the DistSender may record the success of each transaction in a corresponding transaction record. To record the success of a transaction, the DistSender may check the timestamp cache of the range where the first operation of the write transaction occurred to determine whether the timestamp for the write transaction was advanced. If the timestamp was advanced, the transaction may perform a read refresh to determine whether values associated with the transaction had changed. If the read refresh is successful (e.g., no values associated with the transaction had changed), the transaction may commit at the advanced timestamp. If the read refresh fails (e.g., at least some value associated with the transaction had changed), the transaction may be restarted. Based on determining the read refresh was successful and/or that the timestamp was not advanced for a write transaction, the DistSender may change the status of the corresponding transaction record to committed as described herein. The DistSender may send values (e.g., read values) to the transaction coordinator. The transaction coordinator may send the values to the SQL layer. In some cases, the transaction coordinator may also send a request to the DistSender, where the request includes an indication for the DistSender to convert write intents to committed values (e.g., MVCC values). The SQL layer may send the values as described herein to the SQL client that initiated the query (e.g., operating on a client device).

### Read Transaction Execution

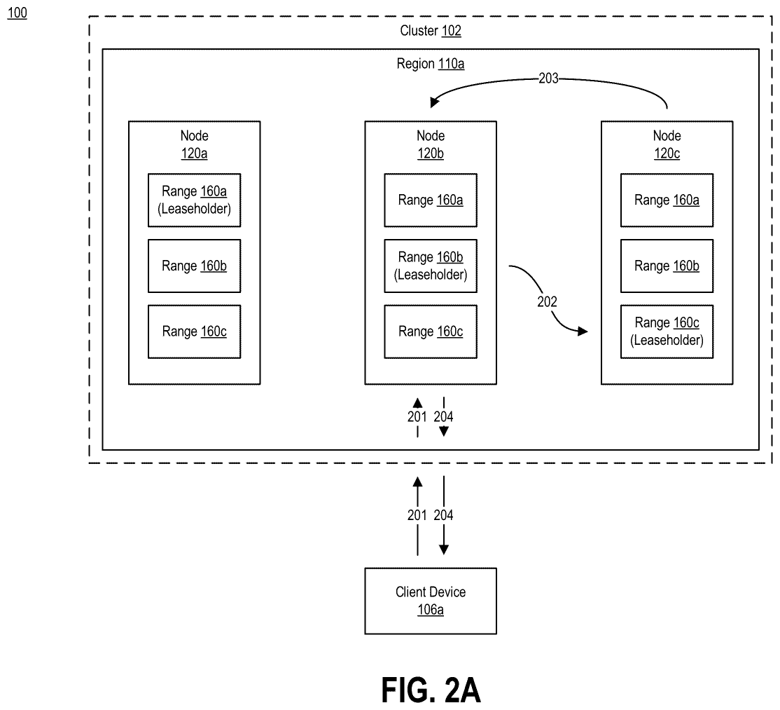

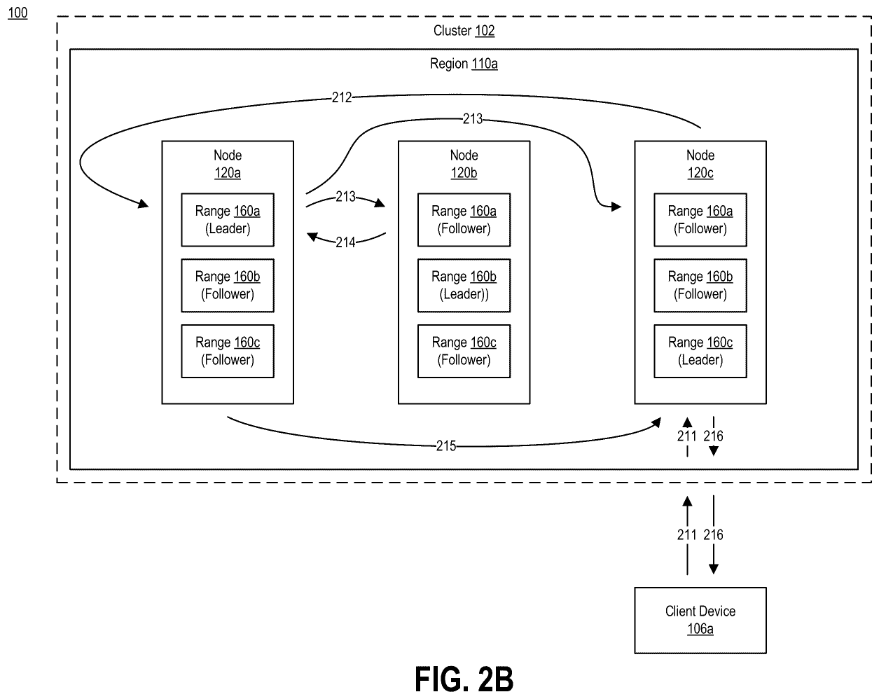

Referring to FIG. 2A, an example of execution of a read transaction at the computing system 100 is presented. In some cases, the nodes 120a, 120b, and 120c, of region 110a may include one or more replicas of ranges 160. The node 120a may include replicas of ranges 160a, 160b, and 160c, where ranges 160a, 160b, and 160c are different ranges. The node 120a may include the leaseholder replica for range 160a (as indicated by “Leaseholder” in FIG. 2A). The node 120b may include replicas of ranges 160a, 160b, and 160c. The node 120b may include the leaseholder replica for range 160b (as indicated by “Leaseholder” in FIG. 2A). The node 120c may include replicas of ranges 160a, 160b, and 160c. The node 120c may include the leaseholder replica for range 160c (as indicated by “Leaseholder” in FIG. 2A). While FIG. 2A is described with respect to communication between nodes 120 of a single region (e.g., region 110a), a read transaction may operate similarly between nodes 120 located within different geographic regions.

In some embodiments, a client device 106 may initiate a read transaction at a node 120 of the cluster 102. Based on the KVs indicated by the read transaction, the node 120 that initially receives the read transaction (e.g., the gateway node) from the client device 106 may route the read transaction to a leaseholder of the range 160 comprising the KVs indicated by the read transaction. The leaseholder of the range 160 may serve the read transaction and send the read data to the gateway node. The gateway node may send the read data to the client device 106.

As shown in FIG. 2A, at step 201, the client device 106 may send a read transaction to the cluster 102. The read transaction may be received by node 120b as the gateway node. The node 120b may be a node 120 located closest to the client device 106, where the closeness between the nodes 120 and a client device 106 may correspond to a latency and/or a proximity as described herein. The read transaction may be directed to data stored by the range 160c. At step 202, the node 120b may route the received read transaction to node 120c. The read transaction may be routed to node 120c based on the node 120c being the leaseholder of the range 160c. The node 120c may receive the read transaction from node 120b and serve the read transaction from the range 160c. At step 203, the node 120c may send the read data to the node 120b. The node 120c may send the read data to node 120b based on the node 120b being the gateway node for the read transaction. The node 120b may receive the read data from node 120c. At step 204, the node 120b may send the read data to the client device 106a to complete the read transaction. If node 120b had been configured to include the leaseholder for the range 160c, the node 120b may have served the read data to the client device directly after step 201, without routing the read transaction to the node 120c.

### Write Transaction Execution

Referring to FIG. 2B, an example of execution of a write transaction at the computing system 100 is presented. In some cases, as described herein, the nodes 120a, 120b, and 120c, of region 110a may include one or more replicas of ranges 160. The node 120a may include replicas of ranges 160a, 160b, and 160c, where ranges 160a, 160b, and 160c are different ranges. The node 120a may include the leaseholder replica and the leader replica for range 160a (as indicated by “Leaseholder” in FIG. 2A and “Leader” in FIG. 2B). The node 120b may include replicas of ranges 160a, 160b, and 160c. The node 120b may include the leader replica for range 160b (as indicated by “Leader” in FIG. 2B). The node 120c may include replicas of ranges 160a, 160b, and 160c. The node 120c may include the leader replica for range 160c (as indicated by “Leader” in FIG. 2B). While FIG. 2B is described with respect to communication between nodes 120 of a single region (e.g., region 110a), a write transaction may operate similarly between nodes 120 located within different geographic regions.

In some embodiments, a client device 106 may initiate a write transaction at a node 120 of the cluster 102. Based on the KVs indicated by the write transaction, the node 120 that initially receives the write transaction (e.g., the gateway node) from the client device 106 may route the write transaction to a leaseholder of the range 160 comprising the KVs indicated by the write transaction. The leaseholder of the range 160 may route the write request to the leader replica of the range 160. In most cases, the leaseholder of the range 160 and the leader replica of the range 160 are the same. The leader replica may append the write transaction to a Raft log of the leader replica and may send the write transaction to the corresponding follower replicas of the range 160 for replication. Follower replicas of the range may append the write transaction to their corresponding Raft logs and send an indication to the leader replica that the write transaction was appended. Based on a threshold number (e.g., a majority) of the replicas indicating and/or sending an indication to the leader replica that the write transaction was appended, the write transaction may be committed by the leader replica. The leader replica may send an indication to the follower replicas to commit the write transaction. The leader replica may send an acknowledgement of a commit of the write transaction to the gateway node. The gateway node may send the acknowledgement to the client device 106.

As shown in FIG. 2B, at step 211, the client device 106 may send a write transaction to the cluster 102. The write transaction may be received by node 120c as the gateway node. The write transaction may be directed to data stored by the range 160a. At step 212, the node 120c may route the received write transaction to node 120a. The write transaction may be routed to node 120a based on the node 120a being the leaseholder of the range 160a. Based on the node 120a including the leader replica for the range 160a, the leader replica of range 160a may append the write transaction to a Raft log at node 120a. At step 213, the leader replica may simultaneously send the write transaction to the follower replicas of range 160a on the node 120b and the node 120c. The node 120b and the node 120c may append the write transaction to their respective Raft logs. At step 214, the follower replicas of the range 160a (at nodes 120b and 120c) may send an indication to the leader replica of the range 160a that the write transaction was appended to their Raft logs. Based on a threshold number of replicas indicating the write transaction was appended to their Raft logs, the leader replica and follower replicas of the range 160a may commit the write transaction. At step 215, the node 120a may send an acknowledgement of the committed write transaction to the node 120c. At step 216, the node 120c may send the acknowledgement of the committed write transaction to the client device 106a to complete the write transaction.

Commit after Distributed Consensus

As described herein, a conventional atomic commit protocol (e.g., 2PC protocol) layered over a distributed consensus protocol would cause a transaction to reach a committed status after a latency greater than or equal to two rounds of distributed consensus among replicas. Further, phases of a conventional atomic commit protocol may include prepare, commit, and release phases.

In some embodiments, as described herein, a conventional atomic commit protocol may include prepare, commit, and release phases each corresponding to a respective round of distributed consensus. During a prepare phase, for each range written to by a received write transaction, the gateway node that initially received the write transaction may send Raft operations and write intents to the leader replica of the respective range. Each leader may send the Raft operations and write intents to their respective follower replicas. Based on a majority of the replicas of each Raft group (e.g., leader replica and follower replicas) acknowledging writing of the write intent and unanimity among the participant ranges, the leader replicas may send an indication of the committed transaction to the gateway node, which may return an indication of the committed transaction to the client device. During a commit phase, a leader replica for the range storing the transaction's transaction record may propose updating the status of the transaction record from pending to committed. The leader replica may send Raft operations and write intents to update the status of the transaction record from pending to committed. Based on a majority of the replicas of the Raft group (e.g., leader replica and follower replicas) acknowledging writing of the updating transaction record status, the leader replica may update the status of the transaction record to committed. During a release phase, participant ranges subject to the transaction may asynchronously release locks and resolve intents by removing pointers to the transaction record corresponding to the transaction. Write operations to remove the pointers to the transaction record at each participant range may include each leader replica sending Raft operations and write intents to their respective follower replicas. Based on a majority of the replicas of each Raft group (e.g., leader replica and follower replicas) acknowledging writing of the write intent and unanimity among the participant ranges, the participant ranges may be available for subsequent transactional operations.

Accordingly, a duration greater than or equal to two rounds of consensus can elapse before completing the commit phase and reaching the release phase of the atomic commit protocol (e.g., updating the transaction record for the transaction to committed). Such a duration results in an unnecessarily large latency for acknowledging a commit for the transaction to the client device (or other application) that initiated the transaction. Accordingly, an improved parallel commit protocol is introduced for enabling transactions to complete the commit phase with reduced latency. The parallel commit protocol may complete the commit phase with reduced latency by performing parallel operations for (i) writing a transaction's intents to replicas of range(s) (e.g., as described with respect to transaction pipelining), and (ii) updating (e.g., marking) the status of the transaction record for the transaction from prepare to staging.

To implement the parallel commits protocol, an additional phase (referred to as a “staging” phase) may be introduced (e.g., between a pending state and a committed state) and a transaction may be redefined as committed based on meeting one of the following conditions: (i) the transaction has a transaction record with a committed status (referred to as being “explicitly committed”), or (ii) the transaction has a transaction record with a staging status and intents written for all write operations indicated as “in-flight” (e.g., sent from the leader replicas to follower replicas for writing by the follower replicas) by an array included in the transaction record at timestamps (e.g., timestamps at which the write intents were written) less than or equal to than a commit timestamp (e.g., as determined at gateway node or advanced based on a transaction conflict or the timestamp cache) of the transaction record. When a transaction begins to commit and to exit the pending state, the transaction first reaches the implicit commit condition by performing parallel operations including (i) updating a status of the transaction's corresponding transaction record (e.g., from pending) to staging, and (ii) writing intents at keys subject to the write operation of the transaction. After updating the status to staging and writing the intents at the keys (e.g., via distributed consensus), the transaction is committed (referred to as “transaction-committed” or “transaction-commit”) and the transaction-commit can be acknowledged to the client device (or other application) before the status of the transaction record is updated to committed.

In some cases, in the parallel commit protocol, a transaction may then move from satisfying the implicit commit condition to satisfying the explicit commit condition by updating the status of the transaction's corresponding transaction record from staging to committed. Such an implementation of the parallel commit protocol may be desirable by modifying the commit condition from a distributed condition that is based on distributed consensus operations to a local condition that is based on updating the status of the transaction's respective transaction record. Regardless, based on satisfaction of either of the implicit or explicit commit conditions, the transaction will remain committed in perpetuity both to itself and to all concurrent observing transactions. Additional features of the parallel commit protocol are described below.

In some embodiments, the transaction layer as described herein may enable the parallel commit protocol. The parallel commit protocol may be an atomic commit protocol that reduces the commit latency of a write transaction (e.g., by reducing the commit latency from greater than or equal to two rounds of consensus operations to greater than or equal to one round of consensus operations). In some cases, the latency incurred by transactions executing via the parallel commits protocol may be substantially close to the sum of all read latencies plus one round of consensus latency. For parallel commits, a transaction coordinator may send a commit acknowledgment to a client device based on determining the write operations of the transaction have succeeded, such that the write intents for the transaction have been written by the leader and follower replicas. Based on determining the write operations in the transaction have succeeded, the transaction coordinator may set the status of the transaction record state to committed and resolve (e.g., asynchronously resolve) the write intents of the transaction.

In some embodiments, a parallel commits protocol may occur based on a number of operations. The parallel commits protocol may operate as follows. A client device may initiate a write transaction. Based on receiving an indication of the started write transaction, a transaction coordinator may be created by the transaction layer at a gateway node to manage a state of the write transaction. The client device may issue a first write operation to a first key (e.g., “Apple”) of a first range. The transaction coordinator may receive the first write operation and may cause generation of a first write intent on the first key (e.g., stored at a leader replica) where the data from the first write operation will be written. The first write intent may include a timestamp (e.g., as determined at gateway node or as an advanced timestamp) and a pointer to a currently nonexistent transaction record for the write transaction. In some cases, each write intent included in the write transaction may be assigned a unique sequence number that uniquely identifies the respective write intent. The transaction coordinator does not need to wait for write intents to replicate from leader replica to follower replicas according to distributed consensus to act on a subsequent statement received from the client device.

In some cases, the client device may issue a second write operation to a second key (e.g., “Berry”) of the first range or a second range as a part of the same write transaction as the first write operation to the first key. The transaction coordinator may receive the second write operation and may cause generation of a second write intent on the second key (e.g., stored at a leader replica) where the data from the second write operation will be written. The second write intent may include a timestamp and a pointer to the same nonexistent transaction record as for the first key based on each write intent being a part of the same transaction. The client device may issue a request to commit the write operations for the write transaction. Based on receiving the request to commit the write operations, the transaction coordinator may create a transaction record. The leader replica(s) at which the first and second write intents were written may send the first and send write intents to their respective follower replicas (e.g., at which the write intents are “in-flight”), where the leader replica(s) and follower replica may vote to commit the first and second write intents. The transaction coordinator may update the status of the transaction record from pending to staging (e.g., assuming the leader replicas have sent write intents to follower replicas). The transaction coordinator may record, in the transaction record, the key(s) of each write operation that has been sent from leader replicas to follower replicas. Based on receiving the commit request from the client device, the transaction coordinator may wait for the pending write intents to be replicated to follower replicas according to distributed consensus. Based on the pending write intents being successfully replicated to the follower replicas via the follower replicas sending acknowledgement of the written intents to their leader replica (e.g., such that each Raft group participating in the transaction is consensus-committed), the transaction may be considered atomically committed (e.g., implicitly committed). Based on receiving an indication that the pending write intents were successfully replicated to the follower replicas via distributed consensus, the transaction may be implicitly committed and the transaction coordinator may send an indication to the client device that the transaction was committed successfully.

In some embodiments, as described herein, the write transaction may be considered atomically committed while the state of the corresponding transaction record is staging. A transaction may be considered to be committed (e.g., atomically committed) based on a pair of logically equivalent states. A logically equivalent state may include the status of the transaction record being staging and successful replication of write intents across the cluster (e.g., according to distributed consensus). Transactions in such a state may be considered implicitly committed as described herein. A logically committed state may include the status of the transaction record being committed. Transactions in such a logically committed state may be considered explicitly committed as described herein.

In some embodiments, the transaction coordinator may update a status of the transaction record from staging to committed, such that other transactions do not encounter a possibly conflicting transaction having the staging status and are not required to verify that the staging transaction's list of pending write intents have succeeded (e.g., been replicated to follower replicas).

In some embodiments, when other transactions encounter a transaction having a staging status, the transactions can issue a query to determine whether the staging transaction is still in progress by verifying that the transaction coordinator is sending heartbeat messages to that staging transaction's transaction record. If the transaction coordinator is still sending heartbeat messages to the transaction record, the other transactions will wait for the staging transaction to commit. The other transactions may wait for the staging transaction based on the theory that letting the transaction coordinator update the transaction record with the result of the attempt to commit will generally be faster than verifying that the staging transaction's list (e.g., array) of pending write intents have succeeded. In practice, verification that the staging transaction's list of pending write intents have succeeded may only be used if the transaction coordinator fails based on a node failure.

Lock Release after Distributed Consensus

As described herein, a conventional atomic commit protocol (e.g., 2PC protocol) layered over a distributed consensus protocol would cause a transaction to complete a release phase after a latency greater than or equal to three rounds of distributed consensus among replicas. Accordingly, a duration greater than or equal to three rounds of consensus can elapse before conflicting read operations and/or write operations from contending transactions are able to execute on KV data subject to a transaction. Such a duration results in an unnecessarily large latency to execute and complete contending transactions, as such transactions are caused to wait on the locks of an executing transaction. Accordingly, an improved contention protocol (referred to as a “lock release protocol”) is introduced to improve execution latency for contending transactions by allowing contending transactions to execute when a transaction is implicitly committed. The lock release protocol may reduce a duration for which a contending transaction waits to be greater than or equal to one round of distributed consensus. The lock release protocol may allow conflicting write operations and read operations to execute when (i) a status of the transaction record for the transaction is updated from pending to staging, and (ii) conditions for commit are verified. The conditions for commit may be verified before a status of the transaction record for the transaction is updated from staging to commit. and before the intents corresponding to the transaction are marked as committed in persistent storage, which both involve respective rounds of distributed consensus. The lock release protocol described herein may operate with a conventional atomic commit protocol (e.g., 2PC protocol) and a parallel commit protocol as described herein. As an example, the lock release protocol may operate based on the simple committed set: (i) after a transaction is explicitly committed for a conventional atomic commit protocol, and (ii) after a transaction is implicitly committed for a parallel commits protocol.

In some embodiments, the lock release protocol may require a number of pre-conditions for operation. A first pre-condition may be that a key (e.g., MVCC key having multiple versions) may be allowed to have multiple intents when at most one of the intents corresponds to an uncommitted transaction (e.g., a transaction that is not implicitly or explicitly committed) and the intent corresponding to an uncommitted transaction (when present) must be the most recent (e.g., newest) version of the key. A second pre-condition may be that a key may be allowed to have multiple intents when version(s) of the key that are not the most recent version of the key (referred to as “stale versions” of the key) are observed as being committed values. Stale versions of a key may be observed as committed values when the stale versions of the key are intents. For intents corresponding to stale versions of a key, (i) the timestamp of the respective intent may be equivalent to the timestamp at which the transaction corresponding to the intent committed and (ii) the value of the respective intent is the value written by the transaction corresponding to the intent.

In some embodiments, one or more mechanisms may enforce the pre-conditions for the lock release protocol. One example mechanism may be identifying a transaction as a “simple-committed” transaction. A simple-committed transaction may refer to a transaction including write operations where (i) each of the intents written by the transaction are written at a timestamp equivalent to the commit timestamp for the transaction (e.g., where the commit timestamp may be different from an original timestamp for the transaction), and (ii) none of the intents were deleted and/or otherwise removed from persistent storage during execution of the transaction. In some cases, SQL transaction “savepoints” may be used to “roll back” one or more written intents by deleting or otherwise removing the intents written at and/or after a particular time during execution of the transaction. A transaction coordinator for a transaction may identify a transaction as a simple-committed transaction based on verifying the above-described conditions at replicas of participating range(s) subject to the transaction after a first round of distributed consensus (e.g., after the leader replica receives acknowledgement of written intents from follower replicas and the write intents are implicitly committed). Based on verifying the conditions for a transaction to be implicitly committed, the transaction coordinator may be able to determine whether a transaction is simple-committed. Based on identifying a transaction to be a simple-committed transaction, the transaction coordinator may send the transaction's unique ID to each of the replicas of the range(s) that were subject to the transaction, thereby providing an indication of the simple-committed transaction to each of the replicas. Each of the replicas may store (e.g., in-memory by volatile, non-persistent storage of a node) a set of indications of the transaction IDs for simple-committed transactions that have operated on the respective replica (referred to as a “simple-committed set”). Based on the possibility for communication failures between nodes, node restarts, and memory capacity bottlenecks in maintaining the full simple-committed set, the simple-committed-set known to and stored by a node can be a subset of the complete simple-committed set.

In some embodiments, as a part of the lock release protocol, intent resolution may execute during a third round of consensus or when a transaction is aborted. Nodes storing replicas subject to a transaction may perform intent resolution as a part of the lock release protocol based on a status of a transaction's corresponding transaction record changing to committed or aborted. A node may resolve intents for a committed transaction that wrote an intent at a first timestamp and committed at a second timestamp by removing and/or otherwise deleting the intent that was written at the first timestamp and writing a committed value (e.g., committed MVCC value stored by persistent storage) at the second timestamp, where the second timestamp is greater than or equal to the first timestamp. For example, a node may resolve intents for a committed transaction “Txn1” that wrote an intent “k” at a first timestamp “t_write” and committed at a second timestamp “t_commit” by removing and/or otherwise deleting the intent “k” and writing a committed value with the second timestamp “t_commit”. A node may resolve intents for an aborted transaction that wrote an intent with a particular timestamp by removing and/or otherwise deleting the intent. For example, a node may resolve intents for an aborted transaction “Txn2” that wrote an intent “k” with a first timestamp “t_write” by removing and/or otherwise deleting the intent “k” at the timestamp “t_write”.

In some cases, for an ongoing transaction without resolved write intents, subsequent transactions may observe a write intent corresponding to the ongoing transaction. For example, when an intent is written at a first timestamp at a particular key of a range by a first transaction, a second transaction attempting to performing a conflicting read operation (e.g., read a value of the key at a second timestamp greater than or equal to the first timestamp) or a conflicting write operation (e.g., write a value to the key). Based on observing the intent and determining the status of the transaction to be pending or staging, the second transaction may proceed as a transaction conflict. As a transaction conflict, the second transaction may wait for the status of the transaction to update to committed or aborted (e.g., as indicated in the transaction record of the first transaction). Waiting for the status of the transaction to update to committed or aborted can include waiting for up to a duration greater than or equal to two rounds of distributed consensus, where (i) a first round of distributed consensus corresponds to updating a status of the transaction record from staging to committed, and (ii) a second round of distributed consensus corresponds to resolving intents for the committed transaction. Additional features of a transaction conflict procedure are described with respect to “Transaction Layer”.

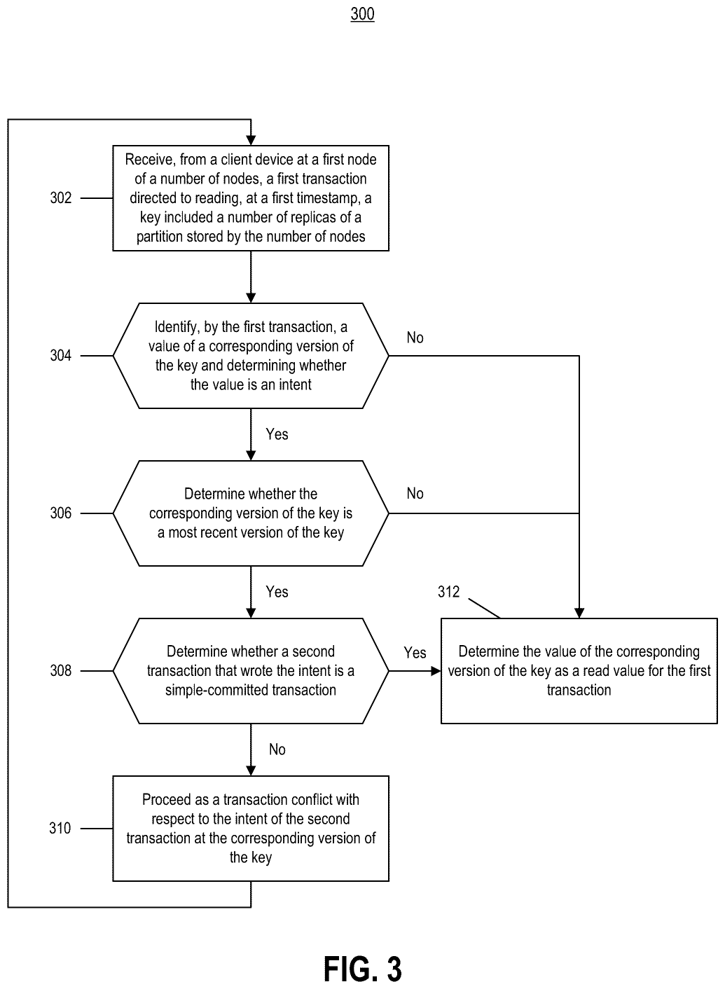

In some embodiments, the lock release protocol may enable improved read latency for a conflicting read transaction that (i) observes an intent written for a key at a first timestamp and (ii) attempts to read the value of the key at a second timestamp greater than or equal to the first timestamp. For a received conflicting read transaction, a node (e.g., node 120) of a cluster (e.g., cluster 102) may execute a method for a lock release protocol based on the conditions described herein with respect to transaction execution. FIG. 3 shows an example flowchart for a method 300 for executing a conflicting read transaction at a computing system (e.g., computing system 100) according to a lock release protocol. The method 300 may be performed by one or more nodes (e.g., nodes 120) based on received communications (e.g., transactional operations) from one or more client devices (e.g., client device 106a, client device 106b, etc.). A result of the method 300 may include reading a value of a key at a particular timestamp or attempting to resolve an observed write intent corresponding to a conflicting transaction. For simplicity, the following paragraphs describe the method 300 with reference to a received read transaction including a read operation directed to reading value of a single key included in a single range replicated by a group of nodes. However, one of ordinary skill in the art will appreciate that the steps 302-312 of the method 300 may be performed for a number of keys corresponding to a number of ranges stored by nodes of the cluster and may be performed in parallel for transactions corresponding to different keys.

At step 302, a first node (e.g., gateway node) of a number of nodes may receive, from a client device, a first transaction directed to reading, at a first timestamp, a key included in a number of replicas of a partition stored by the number of nodes. The number of nodes may store a number of partitions including the partition. The key may have a number of versions each including a respective value and respective timestamp. The respective timestamp may be a timestamp at which the respective value was written and/or committed by a respective transaction that wrote the value. A corresponding version of the number of versions of the key may include a second timestamp that is less than or equal to the first timestamp. In some cases, the corresponding version of the number of versions of the key may be a newest version of the key having a timestamp that is less than or equal to the first timestamp. In some cases, other versions of the number of version of the key may be newer than the corresponding version of the key and may have timestamps that are greater than the first timestamp. The number of replicas may include a leader replica and two or more follower replicas, where the leader replica coordinates a consensus protocol among the leader replica and the two or more follower replicas for committing write operations to the partition. The number of replicas may include a leaseholder replica that coordinates read operations directed to the partition. In some cases, the leaseholder replica is the leader replica. In some cases, the first node may optionally send the first transaction to a second node of the number of database nodes, where the second node stores the leaseholder replica of the partition. In other cases, the first node may store the leaseholder replica of the partition.

At step 304, a read operation included in the first transaction may identify (e.g., read), at the leaseholder replica for the partition based on the first timestamp of the first transaction, the respective value of the corresponding version of the key and may determine whether the value includes an intent. An intent may include a provisional value and a pointer to a transaction record corresponding to a transaction (e.g., a second transaction) directed to writing to the key as described herein. The transaction record corresponding to the second transaction may be included in the partition or a second partition of the number of partitions. The second transaction may have written and/or committed the respective value of the corresponding version of the key at the second timestamp. When the read operation determines the value includes an intent, the method may proceed to step 306. When the read operation determines the value does not include an intent, the first transaction may determine the value includes a committed value (e.g., MVCC value) and the method may proceed to step 312.

At step 306, the read operation included in the first transaction may determine whether the corresponding version of the key is a most recent version of the key. The most recent version of the key may be a version of the key having a largest timestamp. To determine whether the corresponding version of the key is the most recent version of the key, the read operation may identify a key history for the key, where the key history includes indications of the number of versions of the key. From the key history, the read operation may determine whether the respective timestamp of at least one of the versions of the key is greater than the second timestamp. When the read operation determines the respective timestamp of at least one of the versions of the key is not greater than the second timestamp, the read operation may determine the corresponding version of the key is the most recent version of the key and the method may proceed to step 308. When the read operation determines the respective timestamp of at least one of the versions of the key is greater than the second timestamp, the read operation may determine the corresponding version of the key is not the most recent version of the key and the method may proceed to step 312.

At step 308, the read operation may determine whether the second transaction that wrote the intent (e.g., the respective value of the corresponding version of the key) is a simple-committed transaction. In some cases, the second transaction may write one or more intents to one or more keys included in at least one of the number of partitions, where the one or more intents include the intent and where the one or more intents are written at the second timestamp. In some cases, the one or more intents are written at one or more additional timestamps greater than or less than the second timestamp. To determine whether the second transaction is a simple-committed transaction, the read operation may identify a simple-committed set included in each of the number of replicas of the partition and determine whether an indication of the second transaction is included in the simple-committed set. A transaction coordinator operating at the first node may determine whether the second transaction is a simple-committed transaction after the leader node receives an acknowledgement of the second transaction from the one or more follower replicas by determining whether: (i) each of the one or more intents written by the second transaction are written at the second timestamp, (ii) the second timestamp is equivalent to a commit timestamp for the second transaction (e.g., the timestamp at which the second transaction committed), and (iii) zero of the one or more intents were deleted and/or removed from persistent storage (e.g., rolled back) during execution of the second transaction. When the transaction coordinator determines (i) each of the one or more intents written by the second transaction are not written at the second timestamp, (ii) the second timestamp is not equivalent to a commit timestamp for the second transaction, or (iii) at least one of the one or more intents was rolled back during execution of the second transaction, the transaction coordinator may determine the second transaction is not a simple-committed transaction and may not send the indication of the second transaction to each of the replicas of the partition for inclusion in the simple-committed set. When the transaction coordinator determines (i) each of the one or more intents written by the second transaction are written at the second timestamp, (ii) the second timestamp is equivalent to a commit timestamp for the second transaction, and (iii) zero of the one or more intents were rolled back during execution of the second transaction, the transaction coordinator may determine the second transaction is a simple-committed transaction and may send the indication of the second transaction to each of the replicas for inclusion in the simple-committed set. When the read operation determines an indication of the second transaction is not included in the simple-committed set, the read operation may determine the second transaction to not be a simple-committed transaction and the method may proceed to step 310. When the read operation determines an indication of the second transaction is included in the simple-committed set, the read operation may determine the second transaction to be a simple-committed transaction and the method may proceed to step 312.

At step 310, the read operation may proceed as a transaction conflict with respect to the intent. As a transaction conflict, the read operation may identify a status of the second transaction included in the transaction record corresponding to the second transaction. Based on the status of the second transaction, the read operation may (i) wait for an update to the status of the second transaction, (ii) identify the update to the status of the second transaction, and/or (iii) determine a read value based on the number of versions of the key (e.g., for the corresponding version of the key written at the second timestamp) or a third version of the key written at a third timestamp, where the first timestamp is greater than or equal to the third timestamp. In some cases, determining the read value for the corresponding version of the key may be based on waiting for the second transaction to commit. In some cases, determining the read value for the third version of the key committed at the third timestamp may be based on causing the second transaction to abort, where the third version of the key is one version older than the corresponding version of the key. Waiting for the status of the second transaction to update to committed or aborted can include waiting for up to a duration greater than or equal to two rounds of distributed consensus, where (i) a first round of distributed consensus corresponds to updating a status of the transaction record from staging to committed, and (ii) a second round of distributed consensus corresponds to resolving intents for the committed transaction. Accordingly, the determination for whether the second transaction that wrote the intent is a simple-committed transaction (e.g., as described with respect to step 308) can prevent the first transaction from waiting for up to the duration greater than or equal to two rounds of distributed consensus (e.g., as described with respect to step 312). Additional details for managing a transaction conflict between the first transaction (e.g., read transaction) and the second transaction (e.g., blocking write transaction) are described with respect to “Transaction Layer”.

At step 312, the read operation may determine, at the leaseholder replica, the respective value of the corresponding version of the key to be a read value. Based on determining the respective value of the corresponding version of the key to be the read value for the read operation, the first node may send the read value for the read operation to the client device.

With respect to exemplary execution of the method 300, a key “k” may have multiple versions at respective timestamps “t5”, “t4”, “t3”, “t2”, and “t1” in decreasing order (e.g., highest, newest timestamp to lowest, oldest timestamp). The versions of the key k at the timestamps t5, t4, t1 may be intents corresponding to transactions “txn5”, “txn4”, and “txn1”, respectively. For a first transaction including a first read operation at a timestamp “t” that is less than the timestamp t5 and greater than the timestamp t4, the first read operation may determine that the version of the key at the timestamp t4 is not the most recent version of the key. Based on determining that the version of the key at the timestamp t4 is not the most recent version of the key, the first read operation may read the intent for the version of the key at the timestamp t4 as a read value (e.g., based on the pre-conditions described herein) and may send the read value to the client device (e.g., via the gateway node).

Further, with respect to exemplary execution of the method 300, for a second transaction including a second read operation at a timestamp “t” that is greater than the timestamp t5, the second read operation may determine the version of the key at the timestamp t5 is the most recent version of the key k and includes an intent. Based on the second read operation determining that the transaction txn5 corresponding to the version of the key at the timestamp t5 is included in the simple-committed set, the second read operation may read the intent for the version of the key at the timestamp t5 as a read value and may send the read value to the client device (e.g., via the gateway node).

In some cases, with respect to exemplary execution of the method 300, based on the simple committed set being lossy, a third transaction including a third read operation at a timestamp “t” that is greater than the timestamp t5 may not find the transaction txn5 corresponding to the version of the key at the timestamp t5 to be included in the simple-committed set. Accordingly, the third read operation may proceed as a transaction conflict with respect to the version of the key at the timestamp t5, which may include (i) reading the value of the intent corresponding to the version of the key at the timestamp t5 as a read value (e.g., when txn5 is committed), or (ii) reading the value of the intent corresponding to the version of the key at the timestamp t4 as a read value (e.g., when txn5 is aborted).

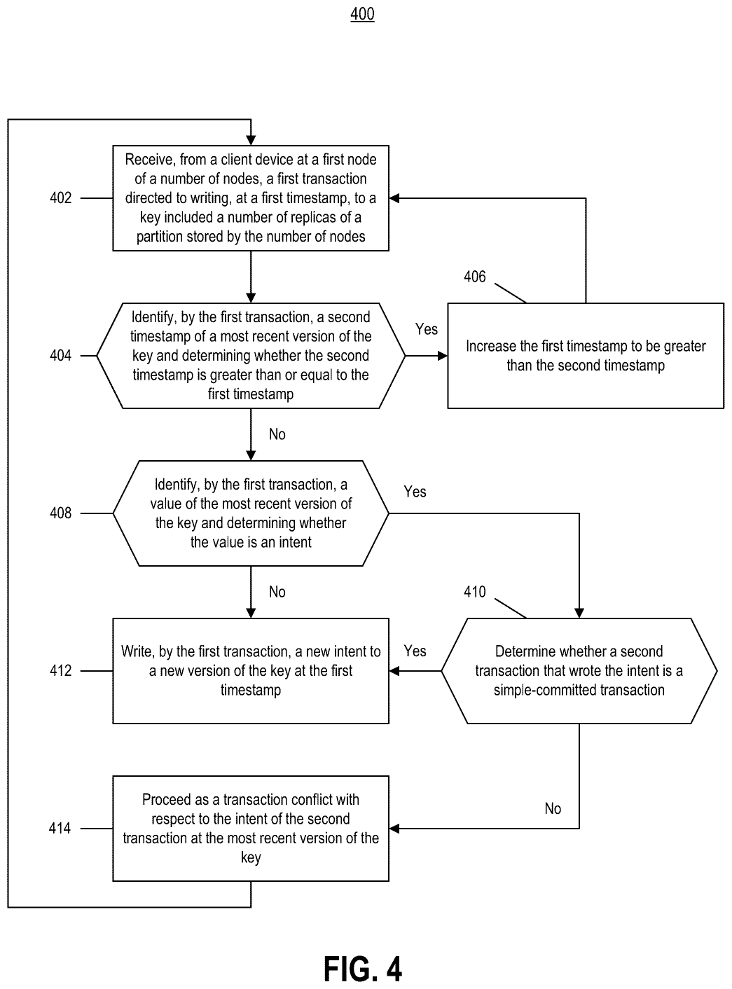

In some embodiments, the lock release protocol may enable improved write latency for a conflicting write transaction that (i) observes an intent written for a key at a first timestamp and (ii) attempts to write a value for the key. For a received conflicting write transaction, a node (e.g., node 120) of a cluster (e.g., cluster 102) may execute a method for a lock release protocol based on the conditions described herein with respect to transaction execution. FIG. 4 shows an example flowchart for a method 400 for executing a conflicting write transaction at a computing system (e.g., computing system 100) according to a lock release protocol. The method 400 may be performed by one or more nodes (e.g., nodes 120) based on received communications (e.g., transactional operations) from one or more client devices (e.g., client device 106a, client device 106b, etc.). A result of the method 400 may include writing a value for a key at a particular commit timestamp or attempting to resolve an observed write intent corresponding to a conflicting transaction. For simplicity, the following paragraphs describe the method 400 with reference to a received write transaction including a write operation directed to writing a value for a single key included in a single range replicated by a group of nodes. However, one of ordinary skill in the art will appreciate that the steps 402-414 of the method 400 may be performed for a number of keys corresponding to a number of ranges stored by nodes of the cluster and may be performed in parallel for transactions corresponding to different keys.

At step 402, a first node (e.g., gateway node) of a number of nodes may receive, from a client device, a first transaction directed to writing, at a first timestamp, to a key included in a number of replicas of a partition stored by the number of nodes. The number of nodes may store a number of partitions including the partition. The key may have a number of versions each including a respective value and respective timestamp. The respective timestamp may be a timestamp at which the respective value was written and/or committed by a respective transaction that wrote the value. A most recent (i.e. newest) version of the number of versions of the key may correspond to a second timestamp. In some cases, the second timestamp may be less than the first timestamp. In other cases, the second timestamp may be greater than or equal to the first timestamp. The number of replicas may include a leader replica and two or more follower replicas, where the leader replica coordinates a consensus protocol among the leader replica and the two or more follower replicas for committing write operations to the partition. The number of replicas may include a leaseholder replica that coordinates read operations directed to the partition. In some cases, the leaseholder replica is the leader replica. In some cases, the first node may optionally send the first transaction to a second node of the number of database nodes, where the second node stores the leader replica of the partition. In other cases, the first node may store the leader replica of the partition.

At step 404, a write operation included in the first transaction may identify the second timestamp of the most recent version of the key and may determine whether the second timestamp is greater than or equal to the first timestamp by comparing the first timestamp to the second timestamp. A second transaction may have written and/or committed the respective value of the most recent version of the key at the second timestamp. When the write operation determines the second timestamp is greater than or equal to the first timestamp, the method may proceed to step 406. When the write operation determines the second timestamp is less than the first timestamp, the method may proceed to step 408.

At step 406, the first transaction may increase the first timestamp to be greater than the second timestamp. For example, the write operation included in the first transaction or the transaction coordinator for the first transaction may increase the first timestamp to be greater than the second timestamp. The first transaction may increase the first timestamp to be greater than the second timestamp based on an inability to rewrite a history of the versions of the key (e.g., based on the history of the versions of the key being immutable). The number of versions of the key (e.g., MVCC history for the key) may be immutable to enable transactional isolation among transactions directed to the key. The number of versions of the key may be ordered from newest to oldest based on the respective timestamps which each version's value was written. A newer version of the number of versions of the key may not have a respective timestamp that is less than a respective timestamp of an older version of the number of versions of the key. A new version of the key that is added to the number of versions of the key may be required to be the newest, most recent version of the number of versions of the key and have a respective timestamp that is greater than each of the respective timestamps of the number of versions of the key. Each of the number of versions of the key may be immutable after creation and storage.

At step 408, the first transaction may identify (e.g., read) the respective value of the most recent version of the key and may determine whether the value includes an intent. For example, the write operation included in the first transaction or the transaction coordinator for the first transaction may read the respective value of the most recent version of the key and may determine whether the value includes an intent. An intent may include a provisional value and a pointer to a transaction record corresponding to a transaction (e.g., the second transaction) directed to writing to the key as described herein. The transaction record corresponding to the second transaction may be included in the partition or a second partition of the number of partitions. The second transaction may have written and/or committed the respective value of the most recent version of the key at the second timestamp. When the first transaction determines the value includes the intent, the method may proceed to step 410. When the first transaction determines the value does not include the intent, the first transaction may determine the value includes a committed value (e.g., MVCC value) and the method may proceed to step 412.

At step 410, the first transaction may determine whether the second transaction that wrote the intent (e.g., the respective value of the most recent version of the key) is a simple-committed transaction. For example, the write operation included in the first transaction or the transaction coordinator for the first transaction may determine whether the second transaction that wrote the intent is a simple-committed transaction. In some cases, the second transaction may write one or more intents to one or more keys included in at least one of a number of partitions, where the one or more intents include the intent and where the one or more intents are written at the second timestamp. In some cases, the one or more intents are written at one or more additional timestamps greater than or less than the second timestamp. To determine whether the second transaction is a simple-committed transaction, the first transaction may identify a simple-committed set included in each of the number of replicas of the partition and determine whether an indication of the second transaction is included in the simple-committed set. A transaction coordinator operating at the first node may determine whether the second transaction is a simple-committed transaction after the leader node receives an acknowledgement of the second transaction from the one or more follower replicas by determining whether: (i) each of the one or more intents written by the second transaction are written at the second timestamp, (ii) the second timestamp is equivalent to a commit timestamp for the second transaction (e.g., the timestamp at which the second transaction committed), and (iii) zero of the one or more intents were deleted and/or removed from persistent storage (e.g., rolled back) during execution of the second transaction. When the transaction coordinator determines (i) each of the one or more intents written by the second transaction are not written at the second timestamp, (ii) the second timestamp is not equivalent to a commit timestamp for the second transaction, or (iii) at least one of the one or more intents was rolled back during execution of the second transaction, the transaction coordinator may determine the second transaction is not a simple-committed transaction and may not send the indication of the second transaction to each of the replicas of the partition for inclusion in the simple-committed set. When the transaction coordinator determines (i) each of the one or more intents written by the second transaction are written at the second timestamp, (ii) the second timestamp is equivalent to a commit timestamp for the second transaction, and (iii) zero of the one or more intents were rolled back during execution of the second transaction, the transaction coordinator may determine the second transaction is a simple-committed transaction and may send the indication of the second transaction to each of the replicas for inclusion in the simple-committed set. When the first transaction determines an indication of the second transaction is included in the simple-committed set, the first transaction may determine the second transaction to be a simple-committed transaction and the method may proceed to step 412. When the first transaction determines an indication of the second transaction is not included in the simple-committed set, the first transaction may determine the second transaction to not be a simple-committed transaction and the method may proceed to step 414.

At step 412, the write operation included in the first transaction may write a new intent to a new version of the key at the first timestamp. The new intent may include a new provisional value and a new pointer to a new transaction record corresponding to the first transaction. The new transaction record corresponding to the first transaction may be included in the partition or a second partition of the number of partitions. Writing the new intent may include executing a distributed consensus algorithm among the leader replica and the follower replicas. The distributed consensus algorithm may include sending, from the leader replica to the follower replicas, the new intent and sending, from the follower replicas to the leader replicas, an acknowledgement of the new intent, such that a majority of replicas included in the group including the leader replica and the follower replica agrees to write the new intent at the new version of the key at the first timestamp (or a third timestamp that is greater than the first timestamp). Based on committing the new intent to the new version of the key at the first timestamp, the first node may send an indication of a success of the first transaction to the client device. Based on the distributed consensus algorithm and based on resolving the new intent at each of the replicas, the write intent may be committed as a committed value.

At step 414, the first transaction may proceed as a transaction conflict with respect to the intent. As a transaction conflict, the first transaction (or the transaction coordinator for the first transaction) may identify a status of the second transaction included in the transaction record corresponding to the second transaction. Based on the status of the second transaction, the first transaction may (i) wait for an update to the status of the second transaction, (ii) identify the update to the status of the second transaction, and/or (iii) write a new intent to a new version of the key at the first timestamp or a third timestamp, where the third timestamp is greater than the first timestamp and the second timestamp. In some cases, writing the new intent to the new version of the key at the first timestamp may be based on waiting for and/or causing the second transaction to abort. In some cases, writing the new intent to the new version of the key at the third timestamp may be based on waiting for the second transaction to commit. Waiting for the status of the second transaction to update to committed or aborted can include waiting for up to a duration greater than or equal to two rounds of distributed consensus, where (i) a first round of distributed consensus corresponds to updating a status of the transaction record from staging to committed, and (ii) a second round of distributed consensus corresponds to resolving intents for the committed transaction. Accordingly, the determination for whether the second transaction that wrote the intent is a simple-committed transaction (e.g., as described with respect to step 410) can prevent the first transaction from waiting for up to the duration greater than or equal to two rounds of distributed consensus to write a new intent to a new version of the key (e.g., as described with respect to step 412). Additional details for managing a transaction conflict between the first transaction (e.g., write transaction) and the second transaction (e.g., blocking write transaction) are described with respect to “Transaction Layer”.

With respect to exemplary execution of the method 400, a key “k” may have multiple versions at respective timestamps “t5”, “t4”, “t3”, “t2”, and “t1” in decreasing order (e.g., highest, newest timestamp to lowest, oldest timestamp. The versions of the key k at the timestamps t5, t4, t1 may be intents corresponding to transactions “txn5”, “txn4”, and “txn1”, respectively. For a first transaction including a first write operation at a timestamp “t6” that is greater than the timestamp t5 and when the transaction txn5 is included in the simple-committed set, the first write operation may write a new intent at a new version of the key at the timestamp t6. The first write operation may write the new intent at the new version of the key at the timestamp t6 while the intent for the version of the key k at timestamp t5 is unresolved, but implicitly committed. In some cases, if the transaction txn5 is missing or otherwise removed from the simple-committed set and a second transaction including a second read operation attempts to read the key k at the timestamp t5, the second read operation may correctly observe the intent corresponding to the version of the key at the timestamp t5 as committed (e.g., implicitly committed) and may read the value of the intent as a read value. Based on determining that the version of the key at the timestamp t4 is not the most recent version of the key, the first read operation may read the intent for the version of the key at the timestamp t4 as a read value (e.g., based on the pre-conditions described herein) and may send the read value to the client device (e.g., via the gateway node).

As described herein, a transaction may write an intent at timestamp “t_write” and may commit at timestamp “t_commit”, where the timestamp t_commit must be greater than or equal to the timestamp t_write. When the timestamp t_commit is greater than the timestamp t_write, the pre-condition for stale versions of a key is not satisfied (e.g., where the timestamp t_commit must be equal to the timestamp t_write), such that the intent written by the transaction is the latest, most recent intent and the intent may be replaced with a committed value having the timestamp t_commit during intent resolution. Further, when the timestamp t_commit is greater than the timestamp t_write, no second transaction may have been able to read the intent and may be forced to proceed as a transaction conflict. When the timestamp t_commit is equal to the timestamp t_write, the transaction may be a simple-committed transaction and a second transaction may safely read the value of the intent at the timestamp t_write.

As described herein, a transaction may write an intent at timestamp “t_write” and may abort. Because no commit timestamp exists for the transaction, the pre-condition for stale versions of a key is not satisfied (e.g., where the commit timestamp must be equal to the timestamp t_write), such that the intent written by the transaction is the latest, most recent intent and the intent may be removed during intent resolution. While the intent is present (e.g., before removal of the intent during intent resolution), no second transaction may have been able to read the intent and may be forced to proceed as a transaction conflict.

### Further Description of Some Embodiments

FIG. 5 is a block diagram of an example computer system 500 that may be used in implementing the technology described in this document. General-purpose computers, network appliances, mobile devices, or other electronic systems may also include at least portions of the system 500. The system 500 includes a processor 510, a memory 520, a storage device 530, and an input/output device 540. Each of the components 510, 520, 530, and 540 may be interconnected, for example, using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530.

The memory 520 stores information within the system 500. In some implementations, the memory 520 is a non-transitory computer-readable medium. In some implementations, the memory 520 is a volatile memory unit. In some implementations, the memory 520 is a non-volatile memory unit.

The storage device 530 is capable of providing mass storage for the system 500. In some implementations, the storage device 530 is a non-transitory computer-readable medium. In various different implementations, the storage device 530 may include, for example, a hard disk device, an optical disk device, a solid-date drive, a flash drive, or some other large capacity storage device. For example, the storage device may store long-term data (e.g., database data, file system data, etc.). The input/output device 540 provides input/output operations for the system 500. In some implementations, the input/output device 540 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 530 may be implemented in a distributed way over a network, for example as a server farm or a set of widely distributed servers, or may be implemented in a single computing device.

Although an example processing system has been described in FIG. 5, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated from the described processes. Accordingly, other implementations are within the scope of the following claims.

### Terminology

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method for executing a conflicting transaction, the method comprising:
receiving, from a client device at a first computing node of a plurality of computing nodes, a first transaction directed to reading, at a first timestamp, a key included in a plurality of replicas of a partition stored by the plurality of computing nodes, wherein the key comprises a plurality of versions each comprising a respective value and a respective timestamp for the value;
identifying, based on the first timestamp, the respective value of a corresponding version of the plurality of versions of the key, wherein the respective timestamp of the corresponding version of the key comprises a second timestamp;
determining the respective value of the corresponding version of the key comprises an intent, wherein the intent was written by a second transaction at the second timestamp; and
determining, based on a type of the second transaction, a provisional value included in the intent as a read value for the first transaction.

2. The method of claim 1, wherein the intent comprises the provisional value and a pointer to a transaction record corresponding to the second transaction, wherein the transaction record indicates a status of the second transaction.

3. The method of claim 1, wherein the identifying the respective value of the corresponding version of the plurality of versions of the key further comprises:
identifying, based on the second timestamp being less than or equal to the first timestamp, the respective value of the corresponding version of the plurality of versions of the key.

4. The method of claim 1, further comprising:
determining the respective value of the corresponding version of the key comprises a committed value, wherein the committed value was committed by the second transaction at the second timestamp; and
determining the committed value as the read value for the first transaction.

5. The method of claim 1, further comprising:
determining, based on the determination the respective value of the corresponding version of the key comprises the intent, the corresponding version of the key is not a most recent version of the key, the determining comprising:
identifying a key history corresponding to the key, wherein the key history comprises indications of the plurality of versions of the key;
comparing the second timestamp to the respective timestamps of the plurality of versions of the key included in the key history; and
determining, based on the comparison of the second timestamp to the respective timestamps of the plurality of versions of the key, at least one timestamp of the respective timestamps of the plurality of versions of the key is greater than the second timestamp.

6. The method of claim 5, wherein the determining the provisional value included in the intent as the read value for the first transaction further comprises:
determining, based on the determination the corresponding version of the key is not the most recent version of the key, the provisional value included in the intent as the read value for the first transaction.

7. The method of claim 1, further comprising:
determining, based on the determination the respective value of the corresponding version of the key comprises the intent, the corresponding version of the key is a most recent version of the key, the determining comprising:
identifying a key history corresponding to the key, wherein the key history comprises indications of the plurality of versions of the key;
comparing the second timestamp to the respective timestamps of the plurality of versions of the key included in the key history; and
determining, based on the comparison of the second timestamp to the respective timestamps of the plurality of versions of the key, the second timestamp is greater than each of the respective timestamps of the plurality of versions of the key.

8. The method of claim 7, further comprising:
determining, based on the determination the corresponding version of the key is the most recent version of the key, the type of the second transaction.

9. The method of claim 1, wherein the type of the second transaction comprises a simple-committed type when (i) each of one or more intents written by the second transaction were written at the second timestamp, wherein the one or more intents comprise the intent, (ii) the second timestamp is equivalent to a commit timestamp for the second transaction, and (iii) zero of the one or more intents were removed during execution of the second transaction.

10. The method of claim 9, wherein the determining the provisional value included in the intent as the read value for the first transaction further comprises:
determining, based on the type of the second transaction comprising the simple-committed type, the provisional value included in the intent as the read value for the first transaction.

11. The method of claim 9, further comprising:
determining, by a transaction coordinator operating at the first computing node, the type of the second transaction comprises the simple-committed type;
sending an indication of the type of the second transaction comprising the simple-committed type to each of the plurality of replicas of the partition; and
storing, by each of the plurality of replicas of the partition, the indication.

12. The method of claim 1, further comprising:
determining the type of the second transaction by identifying an indication of the second transaction comprised in at least one of the plurality of replicas of the partition.

13. The method of claim 1, further comprising:
resolving, based on the type of the second transaction, the intent, by identifying an update to a status of the second transaction.

14. The method of claim 13, wherein the resolving the intent further comprises:
determining, based on the update, the respective value of the corresponding version of the key comprises a committed value, wherein the committed value was committed by the second transaction at the second timestamp; and
determining the committed value as the read value for the first transaction.

15. The method of claim 13, wherein the resolving the intent further comprises:
identifying, based on the update, the respective value of one of the plurality of versions of the key, wherein the respective value was committed by a third transaction at a third timestamp; and
determining the respective value committed by the third transaction as the read value for the first transaction.

16. The method of claim 1, further comprising:
sending, from the first computing node to the client device, the read value for the first transaction.

17. A computer-implemented method for executing a conflicting transaction, the method comprising:
receiving, from a client device at a first computing node of a plurality of computing nodes, a first transaction directed to writing, at a first timestamp, to a key included in a plurality of replicas of a partition stored by the plurality of computing nodes, wherein the key comprises a plurality of versions each comprising a respective value and a respective timestamp for the value;
identifying a second timestamp as the respective timestamp of a most recent version of the plurality of versions of the key, wherein the most recent version of the key comprises the second timestamp;
determining, based on a comparison of the first timestamp to the second timestamp, the respective value of the most recent version of the key comprises a second intent, wherein the second intent was written by a second transaction at the second timestamp; and
writing, based on a type of the second transaction, a new version of the key to the plurality of versions of the key at the first timestamp, where in the new version comprises a first intent comprising a first provisional value and a first pointer to a first transaction record corresponding to the first transaction.

18. The method of claim 17, wherein the second intent comprises a second provisional value and a second pointer to a second transaction record corresponding to the second transaction, wherein the second transaction record indicates a status of the second transaction.

19. The method of claim 17, further comprising:
comparing the first timestamp to the second timestamp; and
increasing, based on the second timestamp being greater than or equal to the first timestamp, the first timestamp to be greater than the second timestamp.

20. The method of claim 17, wherein the determining the respective value of the most recent version of the key comprises the second intent further comprises:
comparing the first timestamp to the second timestamp; and
determining, based on the second timestamp being less than the first timestamp, the respective value of the most recent version of the key comprises the second intent.

21. The method of claim 17, further comprising:
determining the respective value of the most recent version of the key comprises a committed value, wherein the committed value was written by the second transaction at the second timestamp; and
writing, based on the determination the respective value of the most recent version of the key comprises the committed value, the new version to the plurality of versions of the key at the first timestamp.

22. The method of claim 17, further comprising:
determining, based on the determination the respective value of the most recent version of the key comprises the second intent, the type of the second transaction.

23. The method of claim 17, wherein the type of the second transaction comprises a simple-committed type when (i) each of one or more intents written by the second transaction were written at the second timestamp, wherein the one or more intents comprise the intent, (ii) the second timestamp is equivalent to a commit timestamp for the second transaction, and (iii) zero of the one or more intents were removed during execution of the second transaction.

24. The method of claim 23, wherein the writing the new version to the plurality of versions of the key further comprises:
writing, based on the type of the second transaction comprising the simple-committed type, the new version to the plurality of versions of the key.

25. The method of claim 23, further comprising:
determining, by a transaction coordinator operating at the first computing node, the type of the second transaction comprises the simple-committed type;
sending an indication of the type of the second transaction comprising the simple-committed type to each of the plurality of replicas of the partition; and
storing, by each of the plurality of replicas of the partition, the indication.

26. The method of claim 17, further comprising:
determining the type of the second transaction by identifying an indication of the second transaction comprised in at least one of the plurality of replicas of the partition.

27. The method of claim 17, wherein the plurality of replicas of the partition comprise a leader replica and two or more follower replicas, wherein the leader replica is configured to coordinate execution of a consensus protocol for write operations directed to the partition among a group comprising the leader replica and the two or more follower replicas, and wherein the writing the new version of the key to the plurality of versions of the key at the first timestamp further comprises:
sending, from the leader replica to the two or more follower replicas, an indication of the first intent;
sending, from the two or more follower replicas to the leader replica, respective acknowledgements of the first intent; and
committing, at the leader replica, the first intent based on a majority of the group acknowledging the first intent.

28. The method of claim 17, further comprising:
resolving, based on the type of the second transaction, the intent, the resolving comprising:
identifying an update to a status of the second transaction; and
writing, based on the update, the new version of the key to the plurality of versions of the key at the first timestamp or at a third timestamp, wherein the third timestamp is greater than the first timestamp and the second timestamp.

29. The method of claim 17, further comprising:
sending, from the first computing node to the client device, an indication of success for the first transaction.

30. A system for executing a conflicting transaction, the system comprising:
a plurality of computing nodes programmed to perform operations comprising:
receiving, from a client device at a first computing node of the plurality of computing nodes, a first transaction directed to reading, at a first timestamp, a key included in a plurality of replicas of a partition stored by the plurality of computing nodes, wherein the key comprises a plurality of versions each comprising a respective value and a respective timestamp for the value;
identifying, based on the first timestamp, the respective value of a corresponding version of the plurality of versions of the key, wherein the respective timestamp of the corresponding version of the key comprises a second timestamp;
determining the respective value of the corresponding version of the key comprises an intent, wherein the intent was written by a second transaction at the second timestamp; and
determining, based on a type of the second transaction, a provisional value included in the intent as a read value for the first transaction.

31. A system for executing a conflicting transaction, the system comprising:
a plurality of computing nodes programmed to perform operations comprising:
receiving, from a client device at a first computing node of the plurality of computing nodes, a first transaction directed to writing, at a first timestamp, to a key included in a plurality of replicas of a partition stored by the plurality of computing nodes, wherein the key comprises a plurality of versions each comprising a respective value and a respective timestamp for the value;
identifying a second timestamp as the respective timestamp of a most recent version of the plurality of versions of the key, wherein the most recent version of the key comprises the second timestamp;
determining, based on a comparison of the first timestamp to the second timestamp, the respective value of the most recent version of the key comprises a second intent, wherein the second intent was written by a second transaction at the second timestamp; and
writing, based on a type of the second transaction, a new version of the key to the plurality of versions of the key at the first timestamp, where in the new version comprises a first intent comprising a first provisional value and a first pointer to a first transaction record corresponding to the first transaction.
